(19) United States
(12) Patent Application Publication
(10) Pub. No.: US 2024/0212669 A1
(43) Pub. Date: Jun. 27, 2024

(54) SPEECH FILTER FOR SPEECH PROCESSING

(71) Applicant: QUALCOMM Incorporated, San Diego, CA (US)

(72) Inventors: Asif MOHAMMAD, San Diego, CA (US); Fatemeh ALISHAHI, Los Angeles, CA (US); Youngkoen KIM, San Diego, CA (US)

(21) Appl. No.: 18/069,618

(22) Filed: Dec. 21, 2022

(51) Int. Cl. G10L 15/08; G10L 21/0272; G10L 25/51

(52) U.S. Cl. CPC G10L 15/08; G10L 21/0272; G10L 25/51; G10L 2015/088

(57) ABSTRACT

A device includes one or more processors configured to, based on detection of a wake word in an utterance from a first person, obtain first speech signature data associated with the first person. The one or more processors are further configured to selectively enable a speaker-specific speech input filter that is based on the first speech signature data.

### I. FIELD

The present disclosure is generally related to selectively filtering audio data for speech processing.

### II. DESCRIPTION OF RELATED ART

Advances in technology have resulted in smaller and more powerful computing devices. Many of these devices can communicate voice and data packets over wired or wireless networks. Further, many such devices incorporate additional functionality such as a digital still camera, a digital video camera, a digital recorder, and an audio file player. Also, such devices can process executable instructions, including software applications, such as a web browser application, that can be used to access the Internet.

Many of these devices incorporate functionality to interact with users via voice commands. For example, a computing device may include a voice assistant application and one or more microphones to generate audio data based on detected sounds. In this example, the voice assistant application is configured to perform various operations, such as sending commands to other devices, retrieving information, and so forth, responsive to speech of a user.

While a voice assistant application can enable hands-free interaction with the computing device, using speech to control the computing device is not without complications. For example, when the computing device is in a noisy environment, it can be difficult separate speech from background noise. As another example, when multiple people are present, speech from multiple people may be detected, leading to confused input to the computing device and an unsatisfactory user experience.

### III. SUMMARY

According to one implementation of the present disclosure, a device includes one or more processors configured to, based on detection of a wake word in an utterance from a first person, obtain first speech signature data associated with the first person. The one or more processors are further configured to selectively enable a speaker-specific speech input filter that is based on the first speech signature data.

According to another implementation of the present disclosure, a method includes, based on detection of a wake word in an utterance from a first person, obtaining first speech signature data associated with the first person. The method further includes selectively enabling a speaker-specific speech input filter that is based on the first speech signature data.

According to another implementation of the present disclosure, a non-transient computer-readable medium stores instructions that are executable by one or more processors to cause the one or more processors to, based on detection of a wake word in an utterance from a first person, obtain first speech signature data associated with the first person. The instructions are further executable by the one or more processors to selectively enable a speaker-specific speech input filter that is based on the first speech signature data.

According to another implementation of the present disclosure, an apparatus includes means for obtaining, based on detection of a wake word in an utterance from a first person, first speech signature data associated with the first person. The apparatus also includes means for selectively enabling a speaker-specific speech input filter that is based on the first speech signature data.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to selectively filter audio data for speech processing, in accordance with some examples of the present disclosure.

FIG. 2A is a diagram of an illustrative aspect of operations associated with selectively filtering audio data for speech processing, in accordance with some examples of the present disclosure.

FIG. 2B is a diagram of an illustrative aspect of operations associated with selectively filtering audio data for speech processing, in accordance with some examples of the present disclosure.

FIG. 2C is a diagram of an illustrative aspect of operations associated with selectively filtering audio data for speech processing, in accordance with some examples of the present disclosure.

FIG. 3 is a diagram of an illustrative aspect of operations associated with selectively filtering audio data for speech processing, in accordance with some examples of the present disclosure.

FIG. 4 is a diagram of an illustrative aspect of operations associated with selectively filtering audio data for speech processing, in accordance with some examples of the present disclosure.

FIG. 5 is a diagram of an illustrative aspect of operations associated with selectively filtering audio data for speech processing, in accordance with some examples of the present disclosure.

FIG. 6 is a diagram of a first example of a vehicle operable to selectively filter audio data for speech processing, in accordance with some examples of the present disclosure.

FIG. 7 is a diagram of a voice-controlled speaker system operable to selectively filter audio data for speech processing, in accordance with some examples of the present disclosure.

FIG. 8 illustrates an example of an integrated circuit operable to selectively filter audio data for speech processing, in accordance with some examples of the present disclosure.

FIG. 9 is a diagram of a mobile device operable to selectively filter audio data for speech processing, in accordance with some examples of the present disclosure.

FIG. 10 is a diagram of a wearable electronic device operable to selectively filter audio data for speech processing, in accordance with some examples of the present disclosure.

FIG. 11 is a diagram of a camera operable to selectively filter audio data for speech processing, in accordance with some examples of the present disclosure.

FIG. 12 is a diagram of a headset, such as a virtual reality, mixed reality, or augmented reality headset, operable to selectively filter audio data for speech processing, in accordance with some examples of the present disclosure.

FIG. 13 is a diagram of a second example of a vehicle operable to selectively filter audio data for speech processing, in accordance with some examples of the present disclosure.

FIG. 14 is a diagram of an illustrative aspect of operation of components of the system of FIG. 1, in accordance with some examples of the present disclosure.

FIG. 15 is a diagram of a particular implementation of a method of selectively filtering audio data for speech processing that may be performed by the device of FIG. 1, in accordance with some examples of the present disclosure.

FIG. 16 is a diagram of a particular implementation of a method of selectively filtering audio data for speech processing that may be performed by the device of FIG. 1, in accordance with some examples of the present disclosure.

FIG. 17 is a diagram of a particular implementation of a method of selectively filtering audio data for speech processing that may be performed by the device of FIG. 1, in accordance with some examples of the present disclosure.

FIG. 18 is a block diagram of a particular illustrative example of a device that is operable to selectively filter audio data for speech processing, in accordance with some examples of the present disclosure.

### V. DETAILED DESCRIPTION

According to particular aspects disclosed herein, a speaker-specific speech input filter is selectively used to generate speech input to a voice assistant. For example, in some implementations, the speaker-specific speech input filter is enabled responsive to detecting a wake word in an utterance from a particular person. In such implementations, the speaker-specific speech input filter, when enabled, is configured to process received audio data to enhance speech of the particular person. Enhancing the speech of the particular person may include, for example, reducing background noise in the audio data, removing speech of one or more other persons from the audio data, etc.

The voice assistant enables hands-free interaction with a computing device; however, when multiple people are present, operation of the voice assistant can be interrupted or confused due to speech from multiple people. As an example, a first person may initiate interaction with the voice assistant by speaking a wake word followed by a command. In this example, if a second person speaks while the first person is speaking to the voice assistant, the speech of the first person and the speech of the second person may overlap such that the voice assistant is unable to correctly interpret the command from the first person. Such confusion leads to an unsatisfactory user experience and waste (because the voice assistant processes audio data without generating the requested result). To illustrate, such confusion can lead to inaccurate speech recognition, resulting in inappropriate responses from the voice assistant.

Another example may be referred to as barging in. In a barging in situation, the first person may initiate interaction with the voice assistant by speaking the wake word followed by a first command. In this example, the second person can interrupt the interaction between the first person and the voice assistant by speaking the wake word (perhaps followed by a second command) before the voice assistant completes operations associated with the first command. When the second person barges in, the voice assistant may cease performing the operations associated with the first command to attend to input (e.g., the second command) from the second person. Barging in leads to an unsatisfactory user experience and waste in a similar manner as confusion because the voice assistant processes audio data associated with the first command without generating the requested result.

According to a particular aspect, selectively enabling a speaker-specific speech input filter enables an improved user experience and more efficient use of resources (e.g., power, processing time, bandwidth, etc.). For example, the speaker-specific speech input filter may be enabled responsive to detection of a wake word in an utterance from a first person. In this example, the speaker-specific speech input filter is configured, based on speech signature data associated with the first person, to provide filtered audio data corresponding to speech from the first person to the voice assistant. The speaker-specific speech input filter is configured to remove speech from other people (e.g., the second person) from the filtered audio data provided to the voice assistant. Thus, the first person can conduct a voice assistant session without interruption, resulting in improved utilization of resources and an improved user experience.

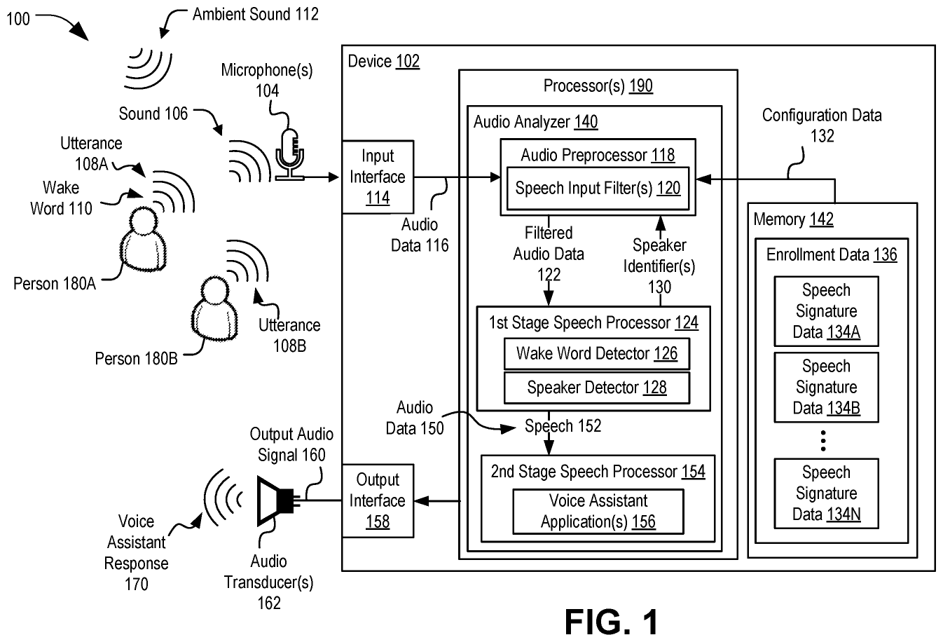

Particular aspects of the present disclosure are described below with reference to the drawings. In the description, common features are designated by common reference numbers. As used herein, various terminology is used for the purpose of describing particular implementations only and is not intended to be limiting of implementations. For example, the singular forms “a,” “an,” and “the” are intended to include the plural forms as well, unless the context clearly indicates otherwise. Further, some features described herein are singular in some implementations and plural in other implementations. To illustrate, FIG. 1 depicts a device 102 including one or more processors (“processor(s)” 190 of FIG. 1), which indicates that in some implementations the device 102 includes a single processor 190 and in other implementations the device 102 includes multiple processors 190. For ease of reference herein, such features are generally introduced as “one or more” features and are subsequently referred to in the singular or optional plural (as generally indicated by “(s)”) unless aspects related to multiple of the features are being described.

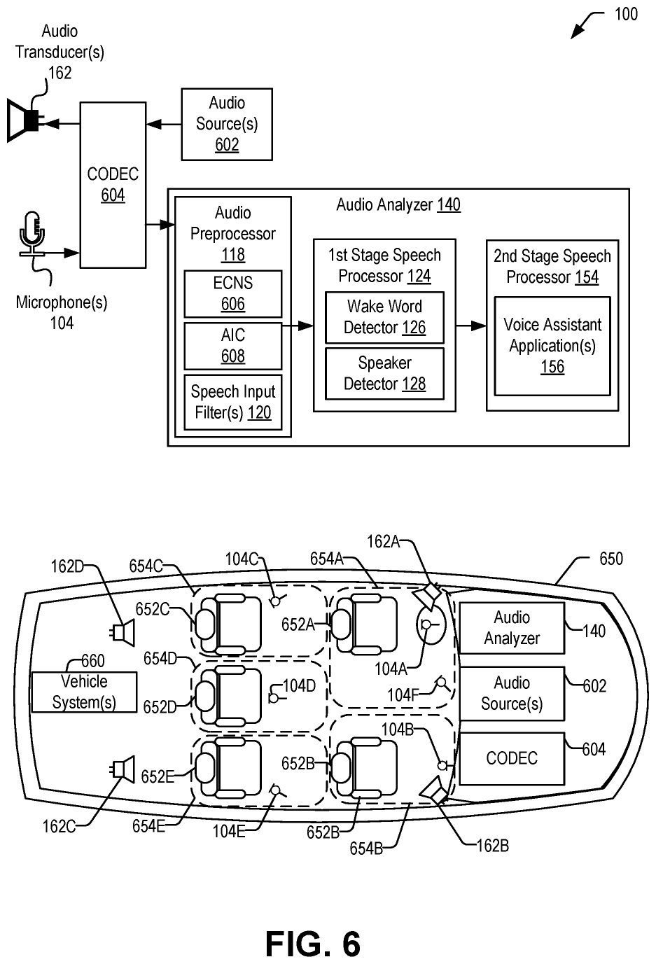

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter. For example, referring to FIG. 6, multiple microphones are illustrated and associated with reference numbers 104A to 104F. When referring to a particular one of these microphones, such as a microphone 104A, the distinguishing letter “A” is used. However, when referring to any arbitrary one of these microphones or to these microphones as a group, the reference number 104 is used without a distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “generating,” “calculating,” “estimating,” “using,” “selecting,” “accessing,” and “determining” may be used interchangeably. For example, “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

FIG. 1 illustrates a particular implementation of a system 100 that is operable to selectively filter audio data provided to one or more voice assistant applications. The system 100 includes a device 102, which includes one or more processors 190 and a memory 142. The device 102 is coupled to or includes one or more microphones 104 coupled via an input interface 114 to the processor(s) 190, and one or more audio transducers 162 (e.g., a loudspeaker) coupled via an output interface 158 to the processor(s) 190.

In FIG. 1, the microphone( ) 104 are disposed in an acoustic environment to receive sound 106. The sound 106 can include, for example, utterances 108 from one or more persons 180, ambient sound 112, or both. The microphone(s) 104 are configured to provide signals to the input interface 114 to generate audio data 116 representing the sound 106. The audio data 116 is provided to the processor(s) 190 for processing, as described further below.

In the example illustrated in FIG. 1, the processor(s) 190 include an audio analyzer 140. The audio analyzer 140 includes an audio preprocessor 118 and a multi-stage speech processor, including a first stage speech processor 124 and a second stage speech processor 154. In a particular implementation, the first stage speech processor 124 is configured to perform wake word detection, and the second stage speech processor 154 is configured to perform more resource intensive speech processing, such as speech-to-text conversion, natural language processing, and related operations. To conserve resources (e.g., power, processor time, etc.) associated with the resource intensive speech processing performed at the second stage speech processor 154, the first stage speech processor 124 is configured to provide audio data 150 to the second stage speech processor 154 after the first stage speech processor 124 detects a wake word 110 in an utterance 108 from a person 180. In some implementations, the second stage speech processor 154 remains in a low-power or standby state until the first stage speech processor 124 signals the second stage speech processor 154 to wake up or enter a high-power state to process the audio data 150. In some such implementations, the first stage speech processor 124 operates in an always on mode, such that the first stage speech processor 124 is always listening for the wake word 110. However, in other such implementations, the first stage speech processor 124 is configured to be activated by some additional operations, such as a button press. A technical benefit of such a multi-stage speech processor is that the most resource intensive operations associated with speech processing can be offloaded to the second stage speech processor 154, which is only active after the wake word 110 is detected, thus conserving power, processor time, and other computing resources associated with operation of the second stage speech processor 154.

Although the second stage speech processor 154 is illustrated in FIG. 1 as included in the device 102, in some implementations, the second stage speech processor 154 is remote from the device 102. For example, the second stage speech processor 154 may be disposed at a remote voice assistant server. In such implementations, the device 102 transmits the audio data 150 via one or more networks to the second stage speech processor 154 after the first stage speech processor 124 detects the wake word 110. A technical benefit of this arrangement is that communications resources associated with transmission of audio data to the second stage speech processor 154 are conserved since the audio data 150 sent to the second stage speech processor 154 represents only a subset of the audio data 116 generated by the microphone(s) 104. Additionally, power, processor time, and other computing resources associated with operation of the second stage speech processor 154 at the remote voice assistant server are conserved by not sending all of the audio data 116 to the remote voice assistant server.

In FIG. 1, the audio preprocessor 118 includes one or more speech input filters 120. At least one of the speech input filter(s) 120 is configurable to operate as a speaker-specific speech input filter. In this context, a “speaker-specific speech input filter” refers to a filter configured to enhance speech of one or more specified persons. For example, a speaker-specific speech input filter associated with the person 180A may be operable to enhance speech of the utterance 108A from the person 180A. To illustrate, enhancing the speech of the person 180A may include de-emphasizing portions (or components) of the audio data 116 that do not correspond to speech from the person 180A, such as portions of the audio data 116 representing the ambient sound 112, portions of the audio data 116 representing the utterance 108B of the person 180B, or both. In the implementation illustrated in FIG. 1, the speech input filter(s) 120 are configured to receive the audio data 116 and to output filtered audio data 122, in which portions or components of the audio data 116 that do not correspond to speech from the person 180A are attenuated or removed.

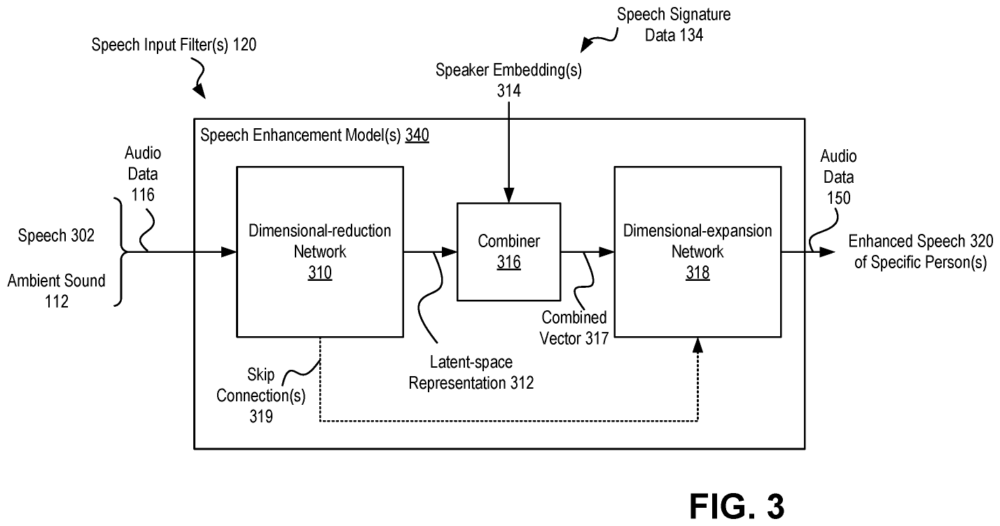

In a particular implementation, the speech input filter(s) 120 are configured to operate as speaker-specific speech input filter(s) based on detection of the wake word 110. For example, responsive to detecting the wake word 110 in the utterance 108A from the person 180A, the speech input filter(s) 120 retrieves speech signature data 134A associated with the person 180A. In this example, the speech input filter(s) 120 use the speech signature data 134A to generate the filtered audio data 122 based on the audio data 116. As a simplified example, the speech input filter(s) 120 compare input audio data (e.g., the audio data 116) to the speech signature data 134A to generate output audio data (e.g., the filtered audio data 122) that de-emphasizes (e.g., removes) portions or components of the input audio data that do not correspond to speech from the person 180A. In some implementations, the speech input filter(s) 120 include one or more trained models, as described further with reference to FIGS. 3-5, and the speech signature data 134 includes one or more speaker embeddings that are provided, along with the audio data 116, as input to the speech input filters(s) 120 to customize the speech input filter(s) 120 to operate as speaker-specific speech input filter(s).

In a particular implementation, the audio analyzer 140 includes a speaker detector 128 that is operable to determine a speaker identifier 130 of a person 180 whose speech is detected, or who is detected speaking the wake word 110. For example, in FIG. 1, the audio preprocessor 118 is configured to provide the filtered audio data 122 to the first stage speech processor 124. In this example, prior to detection of the wake word 110 (e.g., when no voice assistant session is in progress), the audio preprocessor 118 may perform non-speaker-specific filtering operations, such as noise suppression, echo cancellation, etc. In this example, the first stage speech processor 124 includes a wake word detector 126 and the speaker detector 128. The wake word detector 126 is configured to detect one or more wake words, such as the wake word 110, in utterances 108 from one or more persons 180.

In response to detecting the wake word 110, the wake word detector 126 causes the speaker detector 128 to determine an identifier (e.g., the speaker identifier 130) of the person 180 associated with the utterance 108 in which the wake word 110 was detected. In a particular implementation, the speaker detector 128 is operable to generate speech signature data based on the utterance 108 and to compare the speech signature data to speech signature data 134 in the memory 142. The speech signature data 134 in the memory 142 may be included within enrollment data 136 associated with a set of enrolled users associated with the device 102. In this example, the speaker detector 128 provides the speaker identifier 130 to the audio preprocessor 118, and the audio preprocessor 118 retrieves configuration data 132 based on the speaker identifier 130. The configuration data 132 may include, for example, speech signature data 134 of the person 180 associated with the utterance 108 in which the wake word 110 was detected.

In some implementations, the configuration data 132 includes other information in addition to the speech signature data 134 of the person 180 associated with the utterance 108 in which the wake word 110 was detected. For example, the configuration data 132 may include speech signature data 134 associated with multiple persons 180. In such implementations, the configuration data 132 enables the speech input filter(s) 120 to generate the filtered audio data 122 based on speech of two or more specific persons.

Thus, in the example illustrated in FIG. 1, after the wake word 110 is detected in an utterance 108 from a particular person 180, the speech input filter(s) 120 are configured to operate a speaker-specific speech input filter(s) associated with at least the particular person 180 who spoke the wake word 110. Portions of the audio data 116 subsequent to the wake word 110 are processed by the speaker-specific speech input filter(s) such that the audio data 150 provided to the second stage speech processor 154 includes speech 152 of the particular person 180 and omits or de-emphasizes other portions of the audio data 116.

The second stage speech processor 154 includes one or more voice assistant applications 156 that are configured to perform voice assistant operations responsive to commands detected within the speech 152. For example, the voice assistant operations may include accessing information from the memory 142 or from another memory, such as a memory of a remote server device. To illustrate, the speech 152 may include an inquiry regarding local weather conditions, and in response to the inquiry, the voice assistant application(s) 156 may determine a location of the device 102 and send a query to a weather database based on the location of the device 102. As another example, the voice assistant operations may include instructions to control other devices (e.g., smart home devices), to output media content, or other similar instructions. When appropriate, the voice assistant application(s) 156 may generate a voice assistant response 170, and the processor(s) 190 may send an output audio signal 160 to the audio transducers 162 to output the voice assistant response 170. Although the example of FIG. 1 illustrates the voices assistant response 170 provided via the audio transducers 162, in other implementations the voice assistant response 170 may be provided via a display device or another output device coupled to the output interface 158.

A technical benefit of filtering the audio data 116 to remove or de-emphasize portions of the audio data 116 other than the speech 152 of the particular person 180 who spoke the wake word 110 is that such audio filtering operations prevents (or reduces the likelihood of) other persons from barging in to a voice assistant session. For example, when the person 180A speaks the wake word 110, the device 102 initiates a voice assistance session associated with the person 180A and configures the speech input filter(s) 120 to de-emphasize portions of the audio data 116 other than speech of the person 180A. In this example, another person 180B is not able to barge in to the voice assistant session because portions of the audio data 116 associated with utterances 108B of the person 180B are not provided to the first stage speech processor 124, are not provided to the second stage speech processor 154, or both. Reducing barging in improves a user experience associated with the voice assistant application(s) 156. Additionally, reducing barging in may conserve resources of the second stage speech processor 154 when the utterance 108B of the person 180B is not relevant to the voice assistant session associated with the person 180A. For example, if the audio data 150 provided to the second stage speech processor 154 includes irrelevant speech of the person 180B, the voice assistant application(s) 156 use computing resources to process the irrelevant speech. Further, the irrelevant speech may cause the voice assistant application(s) 156 to misunderstand the speech of the person 180A associated with the voice assistant session, resulting in the person 180A having to repeat the speech and the voice assistant application(s) 156 having to repeat operations to analyze the speech. Additionally, the irrelevant speech may reduce accuracy of speech recognition operations performed by the voice assistant application(s) 156.

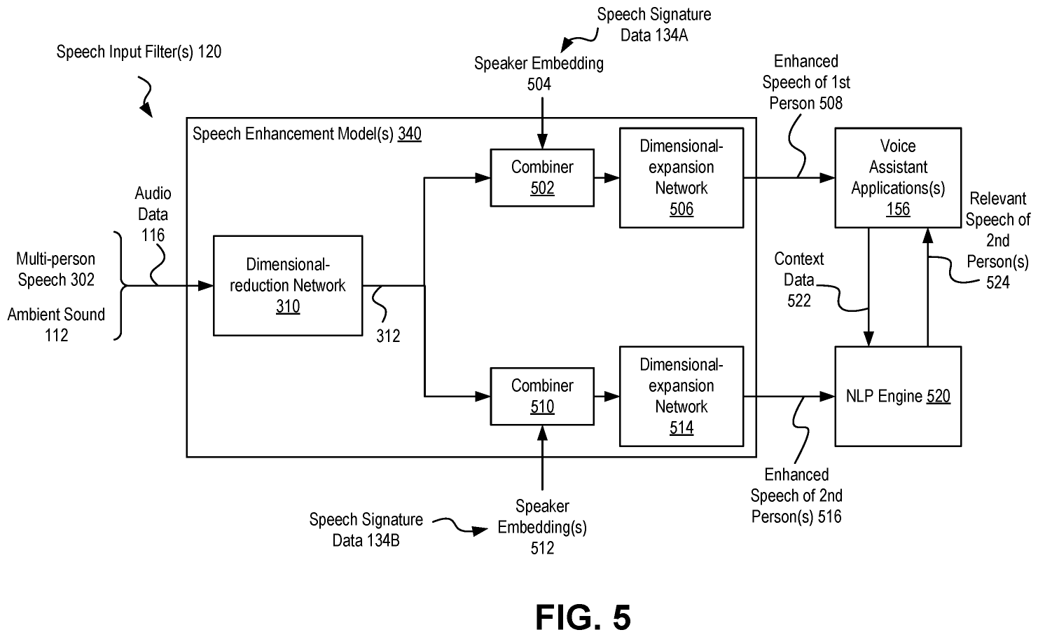

In some implementations, speech that is barging in may be allowed when the speech is relevant to the voice assistant session that is in progress. For example, as described further with reference to FIG. 5, when the audio data 116 includes “barge-in speech” (e.g., speech that is not associated with the person 180 who spoke the wake word 110 to initiate the voice assistant session), the barge-in speech is processed to determine a relevance score, and only barge-in speech associated with a relevance score that satisfies a relevance criterion is provided to the voice assistant application(s) 156.

As one example of operation of the system 100, the microphone(s) 104 detect the sound 106 and provide the audio data 116 to the processor(s) 190. Prior to detection of the wake word 110, the audio preprocessor 118 performs non-speaker-specific audio preprocessing operations such as echo cancellation, noise reduction, etc. Additionally, in some implementations, prior to detection of the wake word 110, the second stage speech processor 154 remains in a low-power state. In some such implementations, the first stage speech processor 124 operates in an always-on mode, and the second stage speech processor 154 operates in a standby mode or low-power mode until activated by the first stage speech processor 124. The audio preprocessor 118 provides the filtered audio data 122 to the first stage speech processor 124 which executes the wake word detector 126 to process the filtered audio data 122 to detect the wake word 110.

When the wake word detector 126 detects the wake word 110 in the utterance 108A from the person 180A, the speaker detector 128 determines the speaker identifier 130 associated with the person 180A. In some implementations, the speaker detector 128 provides the speaker identifier 130 to the audio preprocessor 118, and the audio preprocessor 118 obtains the speech signature data 134A associated with the person 180A. In other implementations, the speaker detector 128 provides the speech signature data 134A to the audio preprocessor 118 as the speaker identifier 130. The speech signature data 134A, and optionally other configuration data 132, are provided to the speech input filter(s) 120 to enable the speech input filter(s) 120 to operate as speaker-specific speech input filter(s) 120 associated with the first person 180A.

Additionally, based on detecting the wake word 110, the wake word detector 126 activates the second stage speech processor 154 and causes the audio data 150 to be provided to the second stage speech processor 154. The audio data 150 includes portions of the audio data 116 after processing by the speaker-specific speech input filter(s) 120. For example, the audio data 150 may include an entirety of the utterance 108 that included the wake word 110 based on processing of the audio data 116 by the speaker-specific speech input filter(s) 120. To illustrate, the audio analyzer 140 may store the audio data 116 in a buffer and cause the audio data 116 stored in the buffer to be processed by the speaker-specific speech input filter(s) 120 in response to detection of the wake word 110. In this illustrative example, the portions of the audio data 116 that were received before the speech input filter(s) 120 are configured to be speaker-specific can nevertheless be filtered using the speaker-specific speech input filter(s) 120 before being provided to the second stage speech processor 154.

In particular implementations, while the speech input filter(s) 120 are configured to operate as speaker-specific speech input filter(s) 120 associated with the person 180A, speech from the person 180B is not provided to the wake word detector 126 and is not provided to the voice assistant application(s) 156. In such implementations, the person 180B is not able to interact with the device 102 in a manner that disrupts the voice assistant session between the person 180A and the voice assistant application(s) 156. In such implementations, the voice assistant session between the person 180A and the voice assistant application(s)156 is initiated when the wake word detector 126 detects the wake word 110 in the utterance 108A from the person 180A and continues until a termination condition is satisfied. For example, the termination condition may be satisfied when a particular duration of the voice assistant session has elapsed, when a voice assistant operation that does not require a response or further interactions with the person 180A is performed, or when the person 180A instructs termination of the voice assistant session.

In some implementations, during a voice assistant session associated with the person 180A, speech from the person 180B may be analyzed to determine whether the speech is relevant to the speech 152 provided to the voice assistant application(s) 156 from the person 180A. In such implementations, relevant speech of the person 180B may be provided to the voice assistant application(s) 156 during the voice assistant session.

In some implementations, the configuration data 132 provided to the audio preprocessor 118 to configure the speech input filter(s) is based on speech signature data 134 associated with multiple persons. In such implementations, the configuration data 132 enables the speech input filter(s) 120 to operate as speaker-specific speech input filter(s) 120 associated with the multiple persons. To illustrate, when configuration data 132 is based on speech signature data 134A associated with the person 180A and speech signature data 134B associated with the person 180B, the speech input filter(s) 120 can be configured to operate as speaker-specific speech input filter(s) 120 associated with the person 180A and the person 180B. An example of an implementation in which the speech signature data 134 based on speech of multiple persons may be used includes a situation in which the person 180A is a child and the person 180B is a parent. In this situation, the parent may have permissions, based on the configuration data 132, that enable the parent to barge in to any voice assistant session initiated by the child.

In a particular implementation, the speech signature data 134 associated with a particular person 180 includes a speaker embedding. For example, during an enrollment operation, the microphone(s) 104 may capture speech of a person 180 and the speaker detector 128 (or another component of the device 102) may generate a speaker embedding. The speaker embedding may be stored at the memory 142 along with other data, such as a speaker identifier of the particular person 180, as the enrollment data 136. In the example illustrated in FIG. 1, the enrollment data 136 includes three sets of speech signature data 134, including speech signature data 134A, speech signature data 134B, and speech signature data 134N. However, in other implementations, the enrollment data 136 includes more than three sets of speech signature data 134 or fewer than three sets of speech signature data 134. The enrollment data 136 optionally also includes information specifying sets of speech signature data 134 that are to be used together, such as in the example above in which a parent's speech signature data 134 is provided to the audio preprocessor 118 along with a child's speech signature data 134.

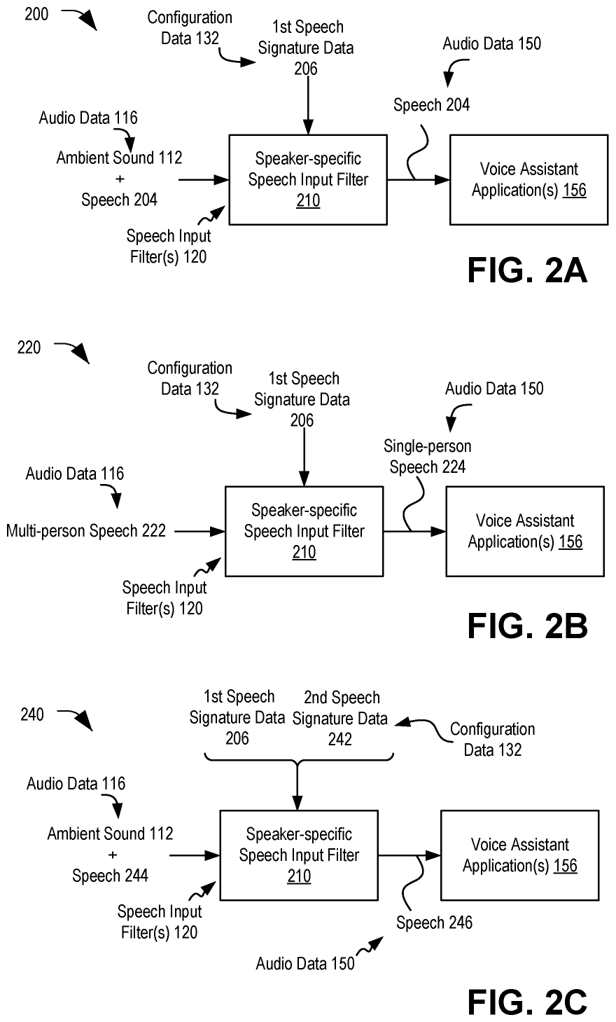

FIGS. 2A-2C illustrate aspects of operations associated with selectively filtering audio data for speech processing, in accordance with some examples of the present disclosure. Referring to FIG. 2A, a first example 200 is illustrated. In the first example 200, the configuration data 132 used to configure the speech input filter(s) 120 to operate as a speaker-specific speech input filter 210 includes first speech signature data 206. The first speech signature data 206 includes, for example, a speaker embedding associated with a first person, such as the person 180A of FIG. 1.

In the first example 200, the audio data 116 provided as input to the speaker-specific speech input filter 210 includes ambient sound 112 and speech 204. The speaker-specific speech input filter 210 is operable to generate as output the audio data 150 based on the audio data 116. In the first example 200, the audio data 150 includes the speech 204 and does not include or de-emphasizes the ambient sound 112. For example, the speaker-specific speech input filter 210 is configured to compare the audio data 116 to the first speech signature data 206 to generate the audio data 150. The audio data 150 de-emphasizes portions of the audio data 116 that do not correspond to the speech 204 from the person associated with the first speech signature data 206.

In the first example 200 illustrated in FIG. 2A, the audio data 150 representing the speech 204 is provided to the voice assistant application(s) 156 as part of a voice assistant session. Further, a portion of the audio data 116 that represents the ambient sound 112 is de-emphasized in or omitted from the audio data 150 provided to the voice assistant application(s) 156. A technical benefit of filtering the audio data 116 to de-emphasize or omit the ambient sound 112 from the audio data 150 is that such filtering enables the voice assistant application(s) 156 to more accurately recognize speech in the audio data 150, which reduces an error rate of the voice assistant application(s) 156 and improves the user experience.

Referring to FIG. 2B, a second example 220 is illustrated. In the second example 220, the configuration data 132 used to configure the speech input filter(s) 120 includes the first speech signature data 206 of FIG. 2A. For example, the first speech signature data 206 includes a speaker embedding associated with a first person, such as the person 180A of FIG. 1.

In the second example 220, the audio data 116 provided as input to the speaker-specific speech input filter 210 includes multi-person speech 222, such as speech of the person 180A and speech of the person 180B of FIG. 1. The speaker-specific speech input filter 210 is operable to generate as output the audio data 150 based on the audio data 116. In the second example 220, the audio data 150 includes single-person speech 224, such as speech of the person 180A. In this example, speech of one or more other persons, such as speech of the person 180B, is omitted from or de-emphasized in the audio data 150. For example, the audio data 150 de-emphasizes portions of the audio data 116 that do not correspond to the speech from the person associated with the first speech signature data 206.

In the second example 220 illustrated in FIG. 2B, the audio data 150 representing the single-person speech 224 (e.g., speech of the person who initiated the voice assistant session) is provided to the voice assistant application(s) 156 as part of the voice assistant session. Further, a portion of the audio data 116 that represents the speech of other persons (e.g., speech of persons who did not initiate the voice assistant session) is de-emphasized in or omitted from the audio data 150 provided to the voice assistant application(s) 156. A technical benefit of filtering the audio data 116 to de-emphasize or omit the speech of persons who did not initiate a particular voice assistant session is that such filtering limits the ability of such other persons to barge in on the voice assistant session.

Although FIG. 2B does not specifically illustrate the ambient sound 112 in the audio data 116 provided to the speaker-specific speech input filter 210, in some implementations, the audio data 116 in the second example 220 also includes the ambient sound 112. In such implementations, the speaker-specific speech input filter 210 performs both speaker separation (e.g., to distinguish the single-person speech 224 from the multi-person speech 222) and noise reduction (e.g., to remove or de-emphasize the ambient sound 112).

Referring to FIG. 2C, a third example 240 is illustrated. In the third example 240, the configuration data 132 used to configure the speech input filter(s) 120 includes the first speech signature data 206 and second speech signature data 242. For example, the first speech signature data 206 includes a speaker embedding associated with a first person, such as the person 180A of FIG. 1, and the second speech signature data 242 includes a speaker embedding associated with a second person, such as the person 180B of FIG. 1.

In the third example 240, the audio data 116 provided as input to the speaker-specific speech input filter 210 includes ambient sound 112 and speech 244. The speech 244 may include speech of the first person, speech of the second person, speech of one or more other persons, or any combination thereof. The speaker-specific speech input filter 210 is operable to generate as output the audio data 150 based on the audio data 116. In the third example 240, the audio data 150 includes speech 246. The speech 246 includes speech of the first person (if any is present in the audio data 116), speech of the second person (if any is present in the audio data 116), or both. Further, in the audio data 150, the ambient sound 112 and speech of other persons are de-emphasized (e.g., attenuated or removed). That is, portions of the audio data 116 that do not correspond to the speech from the first person associated with the first speech signature data 206 or speech from the second person associated with the second speech signature data 242 are de-emphasized in the audio data 150.

In the third example 240 illustrated in FIG. 2C, the audio data 150 representing the speech 246 is provided to the voice assistant application(s) 156 as part of a voice assistant session. Further, a portion of the audio data 116 that represents the ambient sound 112 or speech of other persons is de-emphasized in or omitted from the audio data 150 provided to the voice assistant application(s) 156. A technical benefit of filtering the audio data 116 to de-emphasize or omit the speech of some persons (e.g., persons not associated with the first speech signature data 206 or the second speech signature data 242) while still allowing multi-person speech (e.g., speech from persons associated with the first speech signature data 206 or the second speech signature data 242) to pass to the voice assistant application(s) 156 is that such filtering enables limited barge in capability for particular users. For example, multiple members of a family may be permitted to barge in on one another's voice assistant sessions while other persons are prevented from barging in to voice assistant sessions initiated by the members of the family.

FIG. 3 illustrates a specific example of the speech input filter(s) 120. In the example illustrated in FIG. 3, the speech input filter(s) 120 include or correspond to one or more speech enhancement models 340. The speech enhancement model(s) 340 include one or more machine-learning models that are configured and trained to perform speech enhancement operations, such as denoising, speaker separation, etc. In the example illustrated in FIG. 3, the speech enhancement model(s) 340 include a dimensional-reduction network 310, a combiner 316, and a dimensional-expansion network 318. The dimensional-reduction network 310 includes a plurality of layers (e.g., neural network layers) arranged to perform convolution, pooling, concatenation, and so forth, to generate a latent-space representation 312 based on the audio data 116. In an example, the audio data 116 is input to the dimensional-reduction network 310 as a series of input feature vectors, where each input feature vector of the series represents one or more audio data samples (e.g., a frame or another portion) of the audio data 116, and the dimensional-reduction network 310 generates a latent-space representation 312 associated with each input feature vector. The input feature vectors may include, for example, values representing spectral features of a time-windowed portion of the audio data 116 (e.g., a complex spectrum, a magnitude spectrum, a mel spectrum, a bark spectrum, etc.), cepstral features of a time-windowed portion of the audio data 116 (e.g., mel frequency cepstral coefficients, bark frequency cepstral coefficients, etc.), or other data representing a time-windowed portion of the audio data 116.

The combiner 316 is configured to combine the speaker embedding(s) 314 and the latent-space representation 312 to generate a combined vector 317 as input for the dimensional-expansion network 318. In an example, the combiner 316 includes a concatenator that is configured to concatenate the speaker embedding(s) 314 to the latent-space representation 312 of each input feature vector to generate the combined vector 317.

The dimensional-expansion network 318 includes one or more recurrent layers (e.g., one or more gated recurrent unit (GRU) layers), and a plurality of additional layers (e.g., neural network layers) arranged to perform convolution, pooling, concatenation, and so forth, to generate the audio data 150 based on the combined vector 317.

Optionally, the speech enhancement model(s) 340 may also include one or more skip connections 319. Each skip connection 319 connects an output of one of the layers of the dimensional-reduction network 310 to an input of a respective one of the layers of the dimensional-expansion network 318.

During operation, the audio data 116 (or feature vectors representing the audio data 116) is provided as input to the speech enhancement model(s) 340. The audio data 116 may include speech 302, the ambient sound 112, or both. The speech 302 can include speech of a single person or speech of multiple persons.

The dimensional-reduction network 310 processes each feature vector of the audio data 116 through a sequence of convolution operations, pooling operations, activation layers, recurrent layers, other data manipulation operations, or any combination thereof, based on the architecture and training of the dimensional-reduction network 310, to generate a latent-space representation 312 of the feature vector of the audio data 116. In the example illustrated in FIG. 3, generation of the latent-space representation 312 of the feature vector is performed independently of the speech signature data 134. Thus, the same operations are performed irrespective of who initiated a voice assistant session.

The speaker embedding(s) 314 are speaker specific and are selected based on a particular person (or persons) whose speech is to be enhanced. Each latent-space representation 312 is combined with the speaker embedding(s) 314 to generate a respective combined vector 317, and the combined vector 317 is provided as input to the dimensional-expansion network 318. As described above, the dimensional-expansion network 318 includes at least one recurrent layer, such as a GRU layer, such that each output vector of the audio data 150 is dependent on a sequence of (e.g., more than one of) the combined vectors 317. In some implementations, the dimensional-expansion network 318 is configured (and trained) to generate enhanced speech 320 of a specific person as the audio data 150. In such implementations, the specific person whose speech is enhanced is the person whose speech is represented by the speaker embedding 314. In some implementations, the dimensional-expansion network 318 is configured (and trained) to generate enhanced speech 320 of more than one specific person as the audio data 150. In such implementations, the specific persons whose speech is enhanced are the persons associated with the speaker embeddings 314.

The dimensional-expansion network 318 can be thought of as a generative network that is configured and trained to recreate that portion of an input audio data stream (e.g., the audio data 116) that is similar to the speech of a particular person (e.g., the person associated with the speaker embedding 314). Thus, the speech enhancement model(s) 340 can, using one set of machine-learning operations, perform both noise reduction and speaker separation to generate the enhanced speech 320.

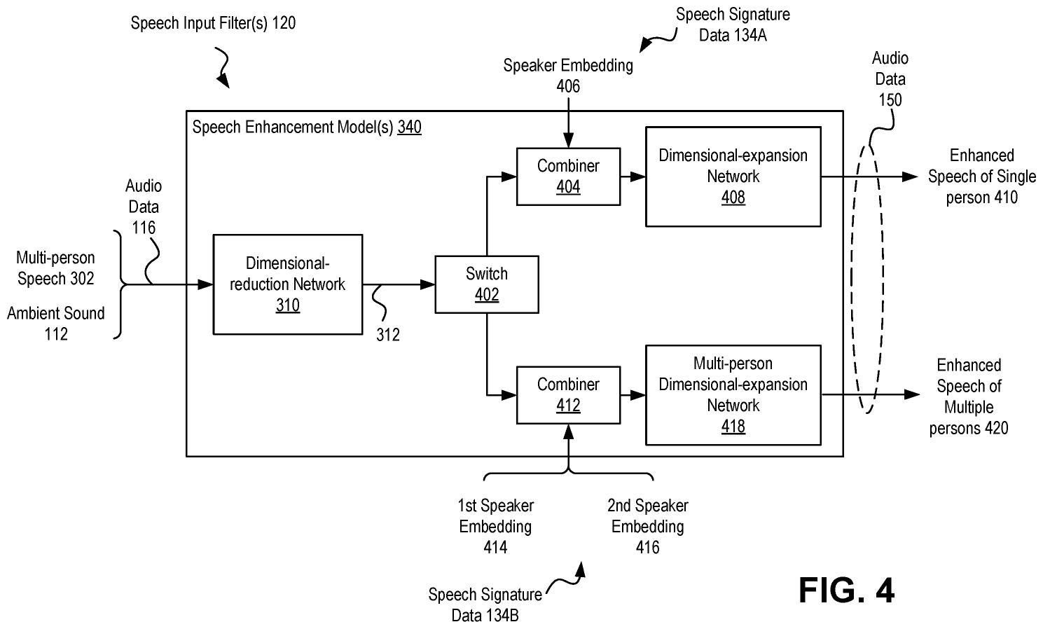

FIG. 4 illustrates another specific example of the speech input filter(s) 120. In the example illustrated in FIG. 4, the speech input filter(s) 120 include or correspond to one or more speech enhancement models 340. As in FIG. 3, the speech enhancement model(s) 340 include one or more machine-learning models that are configured (and trained) to perform speech enhancement operations, such as denoising, speaker separation, etc. In the example illustrated in FIG. 4, the speech enhancement model(s) 340 include the dimensional-reduction network 310 coupled to a switch 402. The switch 402 can include, for example, a logical switch configured to select which of a plurality of subsequent processing paths is performed. The dimensional-reduction network 310 operates as described with reference to FIG. 3 to generate a latent-space representation 312 associated with each input feature vector of the audio data 116.

In the example illustrated in FIG. 4, the switch 402 is coupled to a first processing path that includes a combiner 404 and a dimensional-expansion network 408, and the switch 402 is also coupled to a second processing path that includes a combiner 412 and a multi-person dimensional-expansion network 418. In this example, the first processing path is configured (and trained) to perform operations associated with enhancing speech for a single person, and the second processing path is configured (and trained) to perform operations associated with enhancing speech for multiple persons. Thus, the switch 402 is configured to select the first processing path when the configuration data 132 of FIG. 1 includes a single speaker embedding 406 or otherwise indicates that speech of a single identified speaker is to be enhanced to generate enhanced speech of a single person 410. In contrast, the switch 402 is configured to select the second processing path when the configuration data 132 of FIG. 1 includes multiple speaker embeddings (such as a first speaker embedding 414 and a second speaker embedding 416) or otherwise indicates that speech of multiple identified speakers is to be enhanced to generate enhanced speech of multiple persons 420.

The combiner 404 is configured to combine the speaker embedding 406 and the latent-space representation 312 to generate a combined vector as input for the dimensional-expansion network 408. The dimensional-expansion network 408 is configured to process the combined vector, as described with reference to FIG. 3, to generate the enhanced speech of a single person 410.

The combiner 412 is configured to combine the two or more speaker embeddings (e.g., the first and second speaker embeddings 414, 416) and the latent-space representation 312 to generate a combined vector as input for the multi-person dimensional-expansion network 418. The multi-person dimensional-expansion network 418 is configured to process the combined vector, as described with reference to FIG. 3, to generate the enhanced speech of multiple persons 420. Although the first processing path and the second processing path perform similar operations, different processing paths are used in the example illustrated in FIG. 4 because the combined vectors that are generated by the combiners 404, 412 have different dimensionality. As a result, the dimensional-expansion network 408 and the multi-person dimensional-expansion network 418 have different architectures to accommodate the differently dimensioned combined vectors.

Alternatively, in some implementations, different processing paths are used in FIG. 4 to account for different operations performed by the combiners 404, 412. For example, the combiner 412 may be configured to combine the speaker embeddings 414, 416 in an element-by-element manner such that the combined vectors generated by the combiners 404, 412 have the same dimensionality. To illustrate, the combiner 412 may sum or average a value of each element of the first speaker embedding 414 with a value of a corresponding element of the second speaker embedding 416.

FIG. 5 illustrates another specific example of the speech input filter(s) 120. In the example illustrated in FIG. 5, the speech input filter(s) 120 include or correspond to one or more speech enhancement models 340. As in FIGS. 3 and 4, the speech enhancement model(s) 340 include one or more machine-learning models that are configured (and trained) to perform speech enhancement operations, such as denoising, speaker separation, etc. In the example illustrated in FIG. 5, the speech enhancement model(s) 340 include the dimensional-reduction network 310, which operates as described with reference to FIG. 3 to generate a latent-space representation 312 associated with each input feature vector of the audio data 116.

In the example illustrated in FIG. 5, the dimensional-reduction network 310 is coupled to a first processing path that includes a combiner 502 and a dimensional-expansion network 506 and is coupled to a second processing path that includes a combiner 510 and a dimensional-expansion network 514. In this example, the first processing path is configured (and trained) to perform operations associated with enhancing speech of a first person (e.g., the person who initiated a particular voice assistant session), and the second processing path is configured (and trained) to perform operations associated with enhancing speech of one or more second persons (e.g., a person who, based on the configuration data 132 of FIG. 1, is approved to barge in to the voice assistant session under certain circumstances).

The combiner 502 is configured to combine a speaker embedding 504 (e.g., a speaker embedding associated with the person who spoke the wake word 110 to initiate the voice assistant session) and the latent-space representation 312 to generate a combined vector as input for the dimensional-expansion network 506. The dimensional-expansion network 506 is configured to process the combined vector, as described with reference to FIG. 3, to generate the enhanced speech of the first person 508. Since the first person is the one who initiated the voice assistant session, the enhanced speech of the first person 508 is provided to the voice assistant application(s) 156 for processing.

The combiner 510 is configured to combine a speaker embedding 512 (e.g., a speaker embedding associated with a second person who did not speak the wake word 110 to initiate the voice assistant session) and the latent-space representation 312 to generate a combined vector as input for the dimensional-expansion network 514. The dimensional-expansion network 514 is configured to process the combined vector, as described with reference to FIG. 3 (or FIG. 4 in the case where the speaker embedding(s) 512 correspond to multiple persons, collectively referred to as “the second person”), to generate the enhanced speech of the second person 516. Note that at any particular time, the latent-space representation 312 may include speech of the first person, speech of the second person, neither, or both. Accordingly, in some implementations, each latent-space representation 312 may be processed via both the first processing path and the second processing path.

The second person has conditional access to the voice assistant session. As such, the enhanced speech of the second person 516 is subjected to further analysis to determine whether conditions are satisfied to provide the speech of the second person 516 to the voice assistant application(s) 156. In the example illustrated in FIG. 5, the enhanced speech of the second person 516 is provided to a natural-language processing (NLP) engine 520. Additionally, context data 522 associated with the enhanced speech of the first person 508 is provided to the NLP engine 520. The context data 522 may include, for example, the enhanced speech of the first person 508, data summarizing the enhanced speech of the first person 508 (e.g., keywords from the enhanced speech of the first person 508), results generated by the voice assistant application(s) 156 responsive to the enhanced speech of the first person 508, other data indicative of the content of the enhanced speech of the first person 508, or any combination thereof.

The NLP engine 520 is configured to determine whether the speech of the second person (as represented in the enhanced speech of the second person 516) is contextually relevant to a voice assistant request, a command, an inquiry, or other content of the speech of the first person as indicated by the context data 522. As an example, the NLP engine 520 may perform context-aware semantic embedding of the context data 522, the enhanced speech of the second person 516, or both, to determine a value of a relevance metric associated with the enhanced speech of the second person 516. In this example, the context-aware semantic embedding may be used to map the enhanced speech of the second person 516 to a feature space in which semantic similarity can be estimated based on distance (e.g., cosine distance, Euclidean distance, etc.) between two points, and the relevance metric may correspond to a value of the distance metric. The content of the enhanced speech of the second person 516 may be considered to be relevant to the virtual assistant session if the relevance metric satisfies a threshold.

If the content of the enhanced speech of the second person 516 is considered to be relevant to the virtual assistant session, the NLP engine 520 provides relevant speech of the second person 524 to the voice assistant application(s) 156. Otherwise, if the content of the enhanced speech of the second person 516 is not considered to be relevant to the virtual assistant session, the enhanced speech of the second person 516 is discarded or ignored.

FIG. 6 is a diagram of a first example of a vehicle 650 operable to selectively filter audio data for speech processing, in accordance with some examples of the present disclosure. In FIG. 6, the system 100 or portions thereof are integrated within the vehicle 650, which in the example of FIG. 6 is illustrated as an automobile including a plurality of seats 652A-652E. Although the vehicle 650 is illustrated as an automobile in FIG. 6, in other implementations, the vehicle 650 is a bus, a train, an aircraft, a watercraft, or another type of vehicle configured to transport one or more passengers (which may optionally include a vehicle operator).

The vehicle 650 includes the audio analyzer 140 and one or more audio sources 602. The audio analyzer 140 and the audio source(s) 602 are coupled to the microphone(s) 104, the audio transducer(s) 162, or both, via a CODEC 604. The vehicle 650 of FIG. 6 also includes one or more vehicle systems 660, some or all of which may be coupled to the audio analyzer 140 to enable the voice assistant application(s) 156 to control various operations of the vehicle system(s) 660.

In FIG. 6, the vehicle 650 includes a plurality of microphones 104A-104F. For example, in FIG. 6, each microphone 104 is positioned near a respective one of the seats 652A-652E. In the example of FIG. 6, the positioning of the microphones 104 relative to the seats 652 enables the audio analyzer 140 to distinguish among audio zones 654 of the vehicle 650. In FIG. 6, there is a one-to-one relationship between the audio zones 654 and the seats 652. In some other implementations, one or more of the audio zones 654 includes more than one seat 652. To illustrate, the seats 652C-652E may be associated with a single “back seat” audio zone.

Although the vehicle 650 of FIG. 6 is illustrated as including a plurality of microphones 104A-104F arranged to detect sound within the vehicle 650 and optionally to enable the audio analyzer 140 to distinguish which audio zone 654 includes a source of the sound, in other implementations, the vehicle 650 includes only a single microphone 104. In still other implementations, the vehicle 650 includes multiple microphones 104 and the audio analyzer 140 does not distinguish among the audio zones 654.

In FIG. 6, the audio analyzer 140 includes the audio preprocessor 118, the first stage speech processor 124, and the second stage speech processor 154, each of which operate as described to any of FIGS. 1-5. In the particular example illustrated in FIG. 6, the audio preprocessor 118 includes the speech input filter(s) 120, which are configurable to operate as speaker-specific speech input filters to selectively filter audio data for speech processing.

The audio preprocessor 118 in FIG. 6 also includes an echo cancelation and noise suppression (ECNS) unit 606 and an adaptive interference canceller (AIC) 608. The ECNS unit 606 and the AIC 608 are operable to filter audio data from the microphone(s) 104 independently of the speech input filter(s) 120. For example, the ECNS unit 606, the AIC 608, or both, may perform non-speaker-specific audio filtering operations. To illustrate, the ECNS unit 606 is operable to perform echo cancellation operations, noise suppression operations (e.g., adaptive noise filtering), or both. The AIC 608 is configured to distinguish among the audio zone 654, and optionally, to limit the audio data provided to the first stage speech processor 124, the second stage speech processor 154, or both, to audio from a particular one or more of the audio zones 654. To illustrate, based on configuration of the audio analyzer 140, the AIC 608 may only allow audio from a person in one of the front seats 652A, 652B to be provided to the wake word detector 126, to the voice assistant application(s) 156, or both.

During operation, one or more of the microphone(s) 104 may detect sounds within the vehicle 650 and provide audio data representing the sounds to the audio analyzer 140. When no voice assistant session is in progress, the ECNS unit 606, the AIC 608, or both, process the audio data to generate filtered audio data (e.g., the filtered audio data 122) and provide the filtered audio data to the wake word detector 126. If the wake word detector 126 detects a wake word (e.g., the wake word 110 of FIG. 1) in the filtered audio data, the wake word detector 126 signals the speaker detector 128 to identify a person who spoke the wake word. Additionally, the wake word detector 126 activates the second stage speech processor 154 to initiate a voice assistant session. The speaker detector 128 provides an identifier of the person who spoke the wake word (e.g., the speaker identifier(s) 130) to the audio preprocessor 118, and the audio preprocessor 118 obtains configuration data (e.g., the configuration data 132) to activate the speech input filter(s) 120 as a speaker-specific speech input filter. In some implementations, the wake word detector 126 may also provide information to the AIC 608 to indicate which audio zone 654 the wake word originated in, and the AIC 608 may filter audio data provided to the speech input filter(s) 120 based on the audio zone 654 from which the wake word originated.

The speaker-specific speech input filter is used to filter the audio data and to provide the filtered audio data to the voice assistant application(s) 156, as described with reference to any of FIGS. 1-5. Based on content of speech represented in the filtered audio data, the voice assistant application(s) 156 may control operation of the audio source(s) 602, control operation of the vehicle system(s) 660, or perform other operations, such as retrieve information from a remote data source.

A response (e.g., the voice assistant response 170) from the voice assistant application(s) 156 may be played out to occupants of the vehicle 650 via the audio transducer(s) 162. In the example illustrated in FIG. 6, the audio transducers 162 are disposed near or in particular ones of the audio zones 654, which enables the voice assistant application(s) 156 to provide a response to a particular occupant (e.g., an occupant who initiated the voice assistant session) or to multiple occupants of the vehicle 650.

Selective operation of the speech input filter(s) 120 as speaker-specific speech input filters enables more accurate speech recognition by the voice assistant application(s) 156 since noise and irrelevant speech is removed from the audio data provided to the voice assistant application(s) 156. Additionally, the selective operation of the speech input filter(s) 120 as speaker-specific speech input filters limits the ability of other occupants in the vehicle 650 to barge in to a voice assistant session. For example, if a driver of the vehicle 650 initiates a voice assistant session to request driving directions, the voice assistant session can be associated with only the driver (or as described above with one or more other persons) such that other occupants of the vehicle 650 are not able to interrupt the voice assistant session.

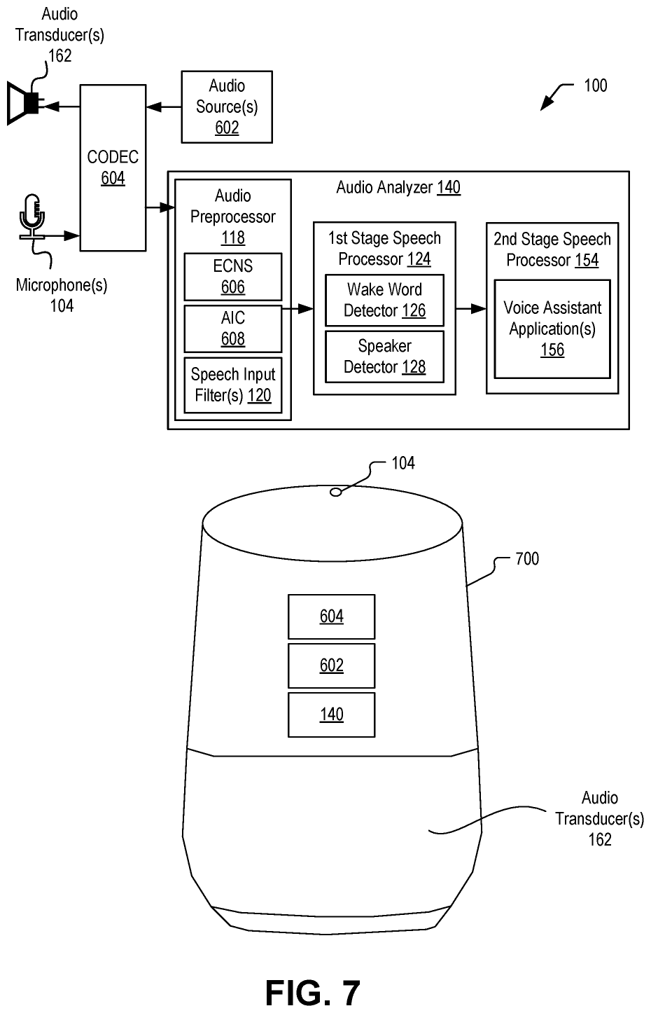

FIG. 7 is an implementation in which the system 100 is integrated within a wireless speaker and voice activated device 700. The wireless speaker and voice activated device 700 can have wireless network connectivity and is configured to execute voice assistant operations. In FIG. 7, the audio analyzer 140, the audio source(s) 602, and the CODEC 604 are included in the wireless speaker and voice activated device 700. The wireless speaker and voice activated device 700 also includes the audio transducer(s) 162 and the microphone(s) 104.

During operation, one or more of the microphone(s) 104 may detect sounds within the vicinity of the wireless speaker and voice activated device 700, such as in a room in which the wireless speaker and voice activated device 700 is disposed. The microphone(s) 104 provide audio data representing the sounds to the audio analyzer 140. When no voice assistant session is in progress, the ECNS unit 606, the AIC 608, or both, process the audio data to generate filtered audio data (e.g., the filtered audio data 122) and provide the filtered audio data to the wake word detector 126. If the wake word detector 126 detects a wake word (e.g., the wake word 110 of FIG. 1) in the filtered audio data, the wake word detector 126 signals the speaker detector 128 to identify a person who spoke the wake word. Additionally, the wake word detector 126 activates the second stage speech processor 154 to initiate a voice assistant session. The speaker detector 128 provides an identifier of the person who spoke the wake word (e.g., the speaker identifier(s) 130) to the audio preprocessor 118, and the audio preprocessor 118 obtains configuration data (e.g., the configuration data 132) to activate the speech input filter(s) 120 as a speaker-specific speech input filter. In some implementations, the wake word detector 126 may also provide information to the AIC 608 to indicate a direction from which the wake word originated, and the AIC 608 may perform beamforming or other directional audio processing to filter audio data provided to the speech input filter(s) 120 based on the direction from which the wake word originated.

The speaker-specific speech input filter is used to filter the audio data and to provide the filtered audio data to the voice assistant application(s) 156, as described with reference to any of FIGS. 1-5. Based on content of speech represented in the filtered audio data, the voice assistant application(s) 156 perform one or more voice assistant operations, such as sending commands to smart home devices, playing out media, or perform other operations, such as retrieve information from a remote data source. A response (e.g., the voice assistant response 170) from the voice assistant application(s) 156 may be played out via the audio transducer(s) 162.

Selective operation of the speech input filter(s) 120 as speaker-specific speech input filters enables more accurate speech recognition by the voice assistant application(s) 156 since noise and irrelevant speech is removed from the audio data provided to the voice assistant application(s) 156. Additionally, the selective operation of the speech input filter(s) 120 as speaker-specific speech input filters limits the ability of other persons in the room with the wireless speaker and voice activated device 700 to barge in to a voice assistant session.

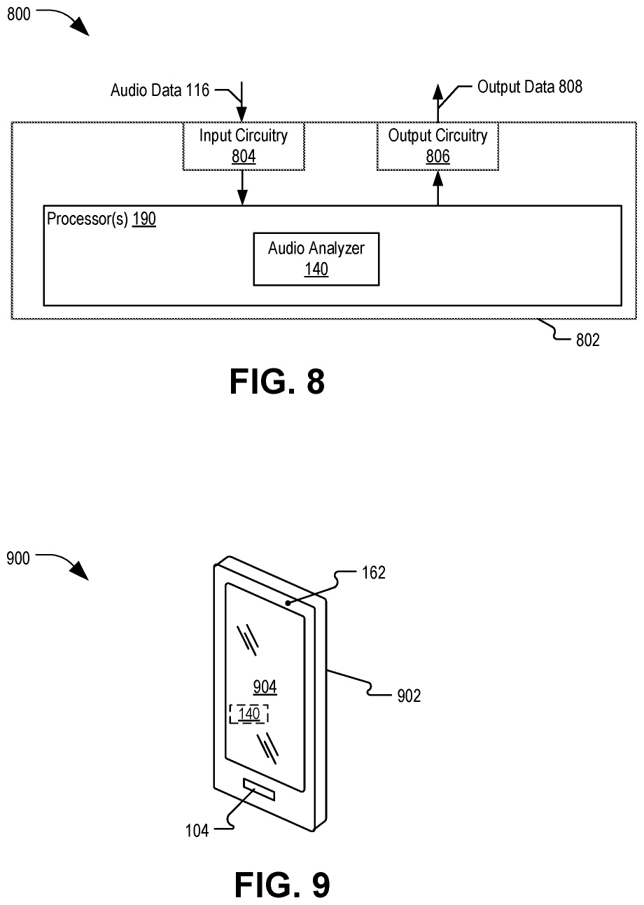

FIG. 8 depicts an implementation 800 of the device 102 as an integrated circuit 802 that includes the one or more processor(s) 190, which include one or more components of the audio analyzer 140. The integrated circuit 802 also includes input circuitry 804, such as one or more bus interfaces, to enable the audio data 116 to be received for processing. The integrated circuit 802 also includes output circuitry 806, such as a bus interface, to enable sending of output data 808 from the integrated circuit 802. For example, the output data 808 may include the voice assistant response 170 of FIG. 1. As another example, the output data 808 may include commands to other devices (such as media players, vehicle systems, smart home devices, etc.) or queries (such as information retrieval queries sent to remote devices). In some implementations, the voice assistant application(s) 156 of FIG. 1 are located remoted from the audio analyzer 140 of FIG. 8, in which case the output data 808 may include the audio data 150 of FIG. 1.

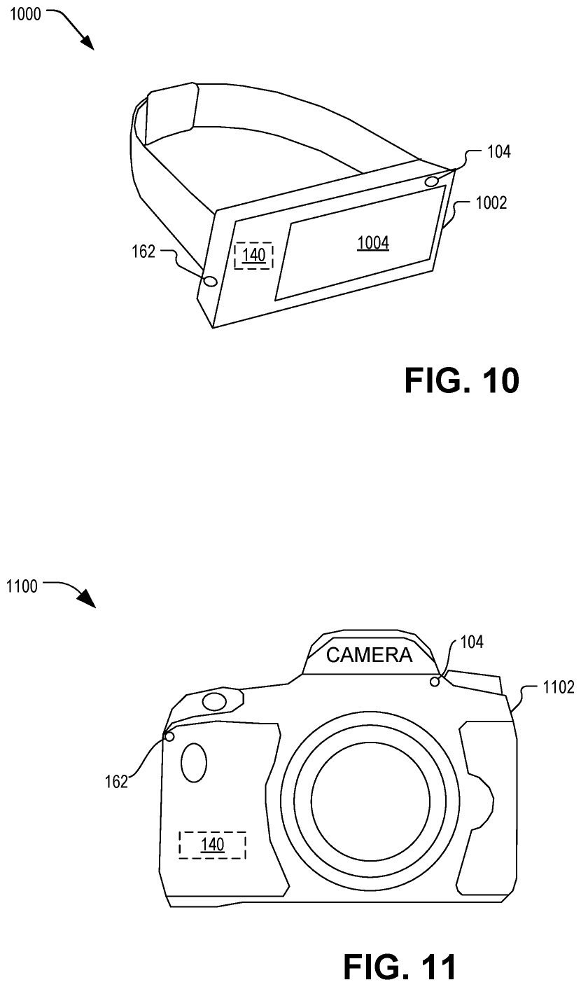

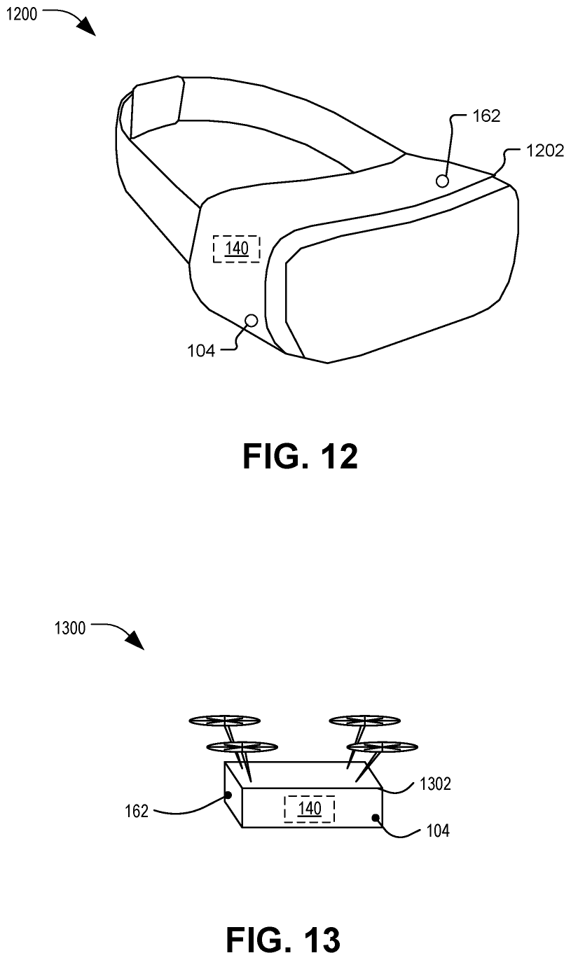

The integrated circuit 802 enables implementation of selectively filtering audio data for speech processing as a component in a system that includes microphones, such as a mobile phone or tablet as depicted in FIG. 9, a wearable electronic device as depicted in FIG. 10, a camera as depicted in FIG. 11, an extended reality (e.g., a virtual reality, mixed reality, or augmented reality) headset as depicted in FIG. 12, or a vehicle as depicted in FIG. 6 or FIG. 13.

FIG. 9 depicts an implementation 900 in which the device 102 includes a mobile device 902, such as a phone or tablet, as illustrative, non-limiting examples. In a particular implementation, the integrated circuit 802 is integrated within the mobile device 902. In FIG. 9, the mobile device 902 includes the microphone(s) 104, the audio transducer(s) 162, and a display screen 904. Components of the processor(s) 190, including the audio analyzer 140, are integrated in the mobile device 902 and are illustrated using dashed lines to indicate internal components that are not generally visible to a user of the mobile device 902.

In a particular example, the audio analyzer 140 of FIG. 9 operates as described with reference to any of FIGS. 1-8 to selectively enable speaker-specific speech input filtering in a manner that improves the accuracy of speech recognition by the voice assistant application(s) 156 and limits the ability of other persons to interrupt a voice assistant session. During a voice assistant session, a response from a voice assistant application may be provided as output to a user via the audio transducer(s) 162, via the display screen 904, or both.

FIG. 10 depicts an implementation 1000 in which the device 102 includes a wearable electronic device 1002, illustrated as a “smart watch.” In a particular implementation, the integrated circuit 802 is integrated within the wearable electronic device 1002. In FIG. 10, the wearable electronic device 1002 includes the microphone(s) 104, the audio transducer(s) 162, and a display screen 1004.

Components of the processor(s) 190, including the audio analyzer 140, are integrated in the wearable electronic device 1002. In a particular example, the audio analyzer 140 of FIG. 10 operates as described with reference to any of FIGS. 1-8 to selectively enable speaker-specific speech input filtering in a manner that improves the accuracy of speech recognition by the voice assistant application(s) 156 and limits the ability of other persons to interrupt a voice assistant session. During a voice assistant session, a response from a voice assistant application may be provided as output to a user via the audio transducer(s) 162, via haptic feedback to the user, via the display screen 1004, or any combination thereof.

As one example of operation of the wearable electronic device 1002, during a voice assistant session, a person who initiates the voice assistant session may provide speech requesting that messages (e.g., text message, email, etc.) sent to the person be displayed via the display screen 1004 of the wearable electronic device 1002. In this example, other persons in the vicinity of the wearable electronic device 1002 may speak a wake word associated with the audio analyzer 140 without interrupting the voice assistant session because audio data is filtered during the voice assistant session to de-emphasize a portion of the audio data that does not correspond to speech of the person who initiated the voice assistant session.

FIG. 11 depicts an implementation 1100 in which the device 102 includes a portable electronic device that corresponds to a camera device 1102. In a particular implementation, the integrated circuit 802 is integrated within the camera device 1102. In FIG. 11, the camera device 1102 includes the microphone(s) 104 and the audio transducer(s) 162. The camera device 1102 may also include a display screen on a side not illustrated in FIG. 11.

Components of the processor(s) 190, including the audio analyzer 140, are integrated in the camera device 1102. In a particular example, the audio analyzer 140 of FIG. 11 operates as described with reference to any of FIGS. 1-8 to selectively enable speaker-specific speech input filtering in a manner that improves the accuracy of speech recognition by the voice assistant application(s) 156 and limits the ability of other persons to interrupt a voice assistant session. During a voice assistant session, a response from a voice assistant application may be provided as output to a user via the audio transducer(s) 162, via the display screen, or both.

As one example of operation of the camera device 1102, during a voice assistant session, a person who initiates the voice assistant session may provide speech requesting that the camera device 1102 capture an image. In this example, other persons in the vicinity of the camera device 1102 may speak a wake word associated with the audio analyzer 140 without interrupting the voice assistant session because audio data is filtered during the voice assistant session to de-emphasize a portion of the audio data that does not correspond to speech of the person who initiated the voice assistant session.

FIG. 12 depicts an implementation 1200 in which the device 102 includes a portable electronic device that corresponds to an extended reality (e.g., a virtual reality, mixed reality, or augmented reality) headset 1202. In a particular implementation, the integrated circuit 802 is integrated within the headset 1202. In FIG. 12, the headset 1202 includes the microphone(s) 104 and the audio transducer(s) 162. Additionally, a visual interface device is positioned in front of the user's eyes to enable display of augmented reality, mixed reality, or virtual reality images or scenes to the user while the headset 1202 is worn.

Components of the processor(s) 190, including the audio analyzer 140, are integrated in the headset 1202. In a particular example, the audio analyzer 140 of FIG. 12 operates as described with reference to any of FIGS. 1-8 to selectively enable speaker-specific speech input filtering in a manner that improves the accuracy of speech recognition by the voice assistant application(s) 156 and limits the ability of other persons to interrupt a voice assistant session. During a voice assistant session, a response from a voice assistant application may be provided as output to a user via the audio transducer(s) 162, via the visual interface device, or both.

As one example of operation of the headset 1202, during a voice assistant session, a person who initiates the voice assistant session may provide speech requesting that particular media be displayed on the visual interface device of the headset 1202. In this example, other persons in the vicinity of the headset 1202 may speak a wake word associated with the audio analyzer 140 without interrupting the voice assistant session because audio data is filtered during the voice assistant session to de-emphasize a portion of the audio data that does not correspond to speech of the person who initiated the voice assistant session.

FIG. 13 depicts an implementation 1300 in which the device 102 corresponds to, or is integrated within, a vehicle 1302, illustrated as a manned or unmanned aerial device (e.g., a package delivery drone). In a particular implementation, the integrated circuit 802 is integrated within the vehicle 1302. In FIG. 13, the vehicle 1302 also includes the microphone(s) 104 and the audio transducer(s) 162.

Components of the processor(s) 190, including the audio analyzer 140, are integrated in the vehicle 1302. In a particular example, the audio analyzer 140 of FIG. 13 operates as described with reference to any of FIGS. 1-8 to selectively enable speaker-specific speech input filtering in a manner that improves the accuracy of speech recognition by the voice assistant application(s) 156 and limits the ability of other persons to interrupt a voice assistant session. During a voice assistant session, a response from a voice assistant application may be provided as output to a user via the audio transducer(s) 162.

As one example of operation of the vehicle 1302, during a voice assistant session, a person who initiates the voice assistant session may provide speech requesting that the vehicle 1302 deliver a package to a specified location. In this example, other persons in the vicinity of the vehicle 1302 may speak a wake word associated with the audio analyzer 140 without interrupting the voice assistant session because audio data is filtered during the voice assistant session to de-emphasize a portion of the audio data that does not correspond to speech of the person who initiated the voice assistant session. As a result, the other persons are unable to redirect the vehicle 1302 to a different delivery location.

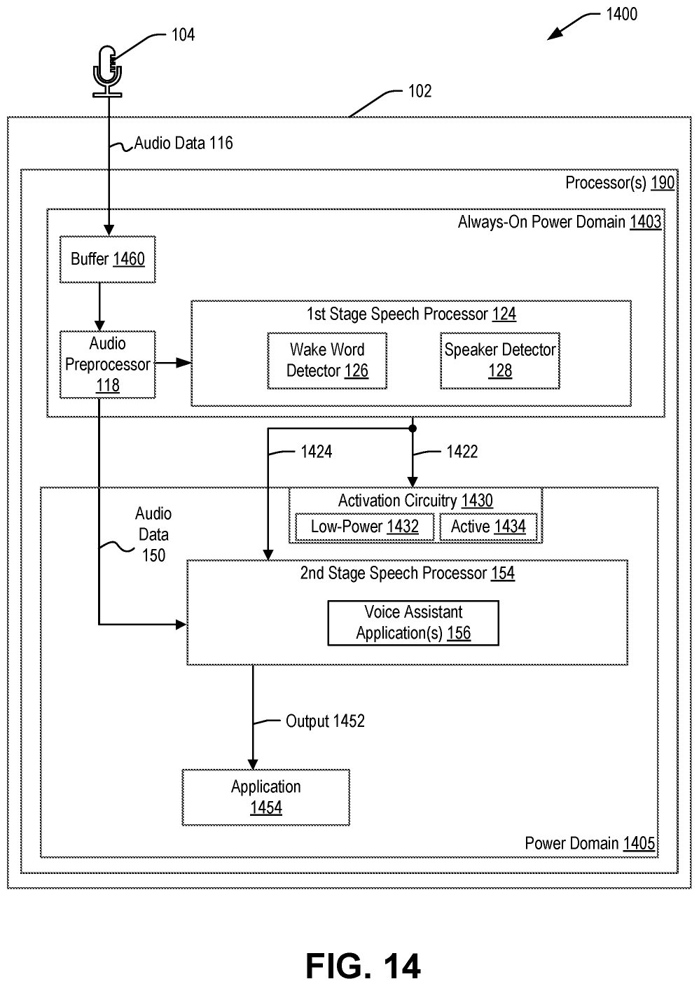

FIG. 14 is a block diagram of an illustrative aspect of a system 1400 operable to selectively filter audio data for speech processing, in accordance with some examples of the present disclosure. In FIG. 14, the processor 190 includes an always-on power domain 1403 and a second power domain 1405, such as an on-demand power domain. Operation of the system 1400 is divided such that some operations are performed in the always-on power domain 1403 and other operations are performed in the second power domain 1405. For example, in FIG. 14, the audio preprocessor 118, the first stage speech processor 124, and a buffer 1460 are included in the always-on power domain 1403 and configured to operate in an always-on mode. Additionally, in FIG. 14, the second stage speech processor 154 is included in the second power domain 1405 and configured to operate in an on-demand mode. The second power domain 1405 also includes activation circuitry 1430.

The audio data 116 received from the microphone(s) 104 is stored in the buffer 1460. In a particular implementation, the buffer 1460 is circular buffer that stores the audio data 116 such that the most recent audio data 116 is accessible for processing other components, such as the audio preprocessor 118, the first stage speech processor 124, the second stage speech processor 154, or a combination thereof.

One or more components of the always-on power domain 1403 are configured to generate at least one of a wakeup signal 1422 or an interrupt 1424 to initiate one or more operations at the second power domain 1405. In an example, the wakeup signal 1422 is configured to transition the second power domain 1405 from a low-power mode 1432 to an active mode 1434 to activate one or more components of the second power domain 1405. As one example, the wake word detector 126 may generate the wakeup signal 1422 or the interrupt 1424 when the wake word is detected in the audio data 116.

In various implementations, the activation circuitry 1430 includes or is coupled to power management circuitry, clock circuitry, head switch or foot switch circuitry, buffer control circuitry, or any combination thereof. The activation circuitry 1430 may be configured to initiate powering-on of the second power domain 1405, such as by selectively applying or raising a voltage of a power supply of the second power domain 1405. As another example, the activation circuitry 1430 may be configured to selectively gate or un-gate a clock signal to the second power domain 1405, such as to prevent or enable circuit operation without removing a power supply.

An output 1452 generated by the second stage speech processor 154 may be provided to an application 1454. The application 1454 may be configured to perform operations as directed by the voice assistant application(s) 156. To illustrate, the application 1454 may correspond to a vehicle navigation and entertainment application, or a home automation system, as illustrative, non-limiting examples.

In a particular implementation, the second power domain 1405 may be activated when a voice assistant session is active. As one example of operation of the system 1400, the audio preprocessor 118 operates in the always-on power domain 1403 to filter the audio data 116 accessed from the buffer 1460 and provide the filtered audio data to the first stage speech processor 124. In this example, when no voice assistant session is active, the audio preprocessor 118 operates in a non-speaker specific manner, such as by performing echo cancellation, noise suppression, etc.

When the wake word detector 126 detects a wake word in the filtered audio data from the audio preprocessor 118, the first stage speech processor 124 causes the speaker detector 128 to identifier a person who spoke the wake word, sends the wakeup signal 1422 or the interrupt 1424 to the second power domain 1405, and causes the audio preprocessor 118 to obtain configuration data associated with the person who spoke the wake word.

Based on the configuration data, the audio preprocessor 118 begins operating in a speaker-specific mode, as described with reference to any of FIGS. 1-5. In the speaker-specific mode, the audio preprocessor 118 provides the audio data 150 to the second stage speech processor 154. The audio data 150 is filtered, by the speaker-specific speech input filter, to de-emphasize, attenuate, or remove portions of the audio data 116 that do not correspond to speech of specific person(s) whose speech signature data are provided to the audio preprocessor 118 with the configuration data. In some implementations, the audio preprocessor 118 also provides the audio data 150 to the first stage speech processor 124 until the voice assistant session is terminated.

By selectively activating the second stage speech processor 154 based on a result of processing audio data at the first stage speech processor 124, overall power consumption associated with speech processing may be reduced.

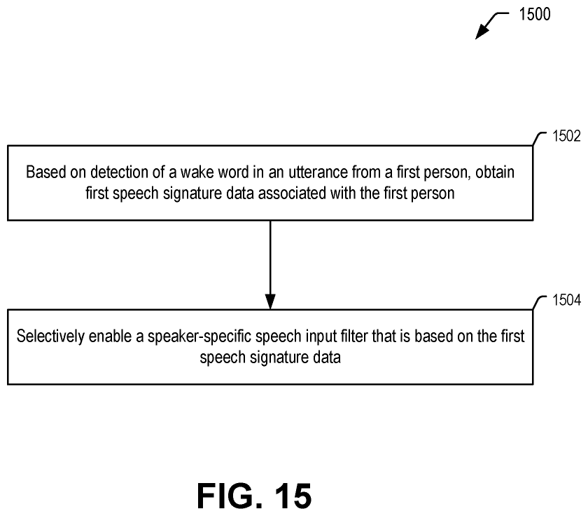

Referring to FIG. 15, a particular implementation of a method 1500 of selectively filtering audio data for speech processing is shown. In a particular aspect, one or more operations of the method 1500 are performed by at least one of the audio analyzer 140, the processor 190, the device 102, the system 100 of FIG. 1, or a combination thereof.

The method 1500 includes, at block 1502, based on detection of a wake word in an utterance from a first person, obtaining first speech signature data associated with the first person. For example, the audio preprocessor 118 may obtain the configuration data 132 of FIG. 1 based on the wake word detector 126 detecting the wake word 110 in the utterance 108A from the person 180A. In this example, the configuration data 132 includes at least speech signature data 134A associated with the person 180A.

The method 1500 includes, at block 1504, selectively enabling a speaker-specific speech input filter that is based on the first speech signature data. For example, the configuration data 132 of FIG. 1 enables the speech input filter 120 of the audio preprocessor 118 to operate in a speaker-specific mode. One benefit of selectively enabling speaker-specific filtering of audio data is that such filtering can improve accuracy of speech recognition by a voice assistant application. Another benefit of selectively enabling speaker-specific filtering of audio data is that such filtering can limit the ability of other persons to interrupt a voice assistant session.

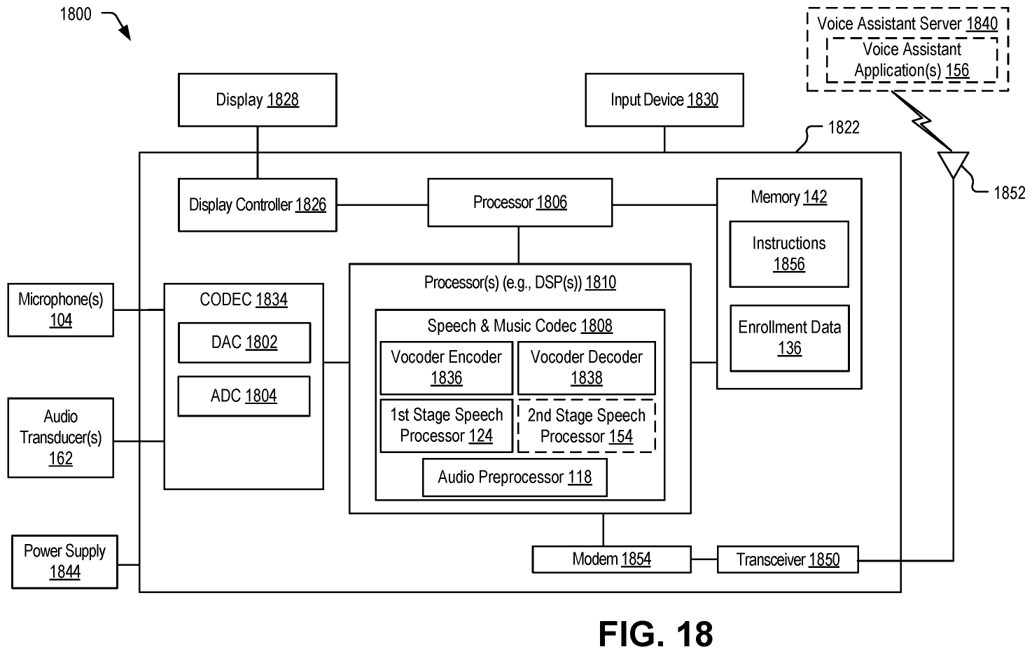

The method 1500 of FIG. 15 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1500 of FIG. 15 may be performed by a processor that executes instructions, such as described with reference to FIG. 18.

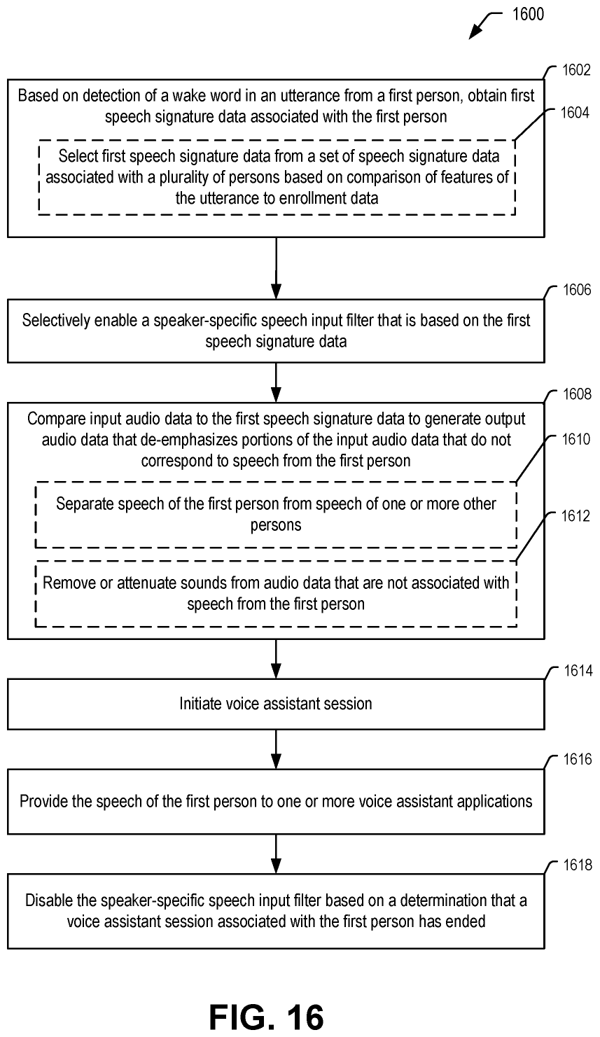

Referring to FIG. 16, a particular implementation of a method 1600 of selectively filtering audio data for speech processing is shown. In a particular aspect, one or more operations of the method 1600 are performed by at least one of the audio analyzer 140, the processor 190, the device 102, the system 100 of FIG. 1, or a combination thereof.

The method 1600 includes, at block 1602, based on detection of a wake word in an utterance from a first person, obtaining first speech signature data associated with the first person. For example, the audio preprocessor 118 may obtain the configuration data 132 of FIG. 1 based on the wake word detector 126 detecting the wake word 110 in the utterance 108A from the person 180A. In this example, the configuration data 132 includes at least speech signature data 134A associated with the person 180A. In the example illustrated in FIG. 16, obtaining first speech signature data associated with the first person includes, at block 1604, selecting the first speech signature data from a set of speech signature data associated with a plurality of persons based on comparison of features of the utterance to enrollment data. For example, the speaker detector 128 may compare features of the utterance 108A to features of the enrollment data 136 (e.g. to the speech signature data 134) to determine the speaker identifier 130 that is used to select the speech signature data 134A associated with the person 180A who spoke the wake word 110.

The method 1600 includes, at block 1606, selectively enabling a speaker-specific speech input filter that is based on the first speech signature data. For example, the configuration data 132 of FIG. 1 enables the speech input filter 120 of the audio preprocessor 118 to operate in a speaker-specific mode.

The method 1600 also includes, at block 1608, comparing input audio data to the first speech signature data to generate output audio data that de-emphasizes portions of the input audio data that do not correspond to speech from the first person. In the example illustrated in FIG. 16, de-emphasizing portions of the input audio data that do not correspond to speech from the first person can include, at block 1610, separating speech of the first person from speech of one or more other persons, at block 1612, removing or attenuating sounds from audio data that are not associated with speech from the first person, or both. For example, as described with reference to FIGS. 2A-2C, the configuration data 132 can include speech signature data of one or more persons and be provided as input to the speech input filter(s) 120 to enable the speech input filter(s) 120 to operate as a speaker-specific speech input filter 210. The speaker-specific speech input filter 210 can de-emphasize portions of the audio data 116 that do not correspond to speech from the one or more persons, such as by removing or attenuating ambient sound 112, etc.

The method 1600 also includes, at block 1614, initiating a voice assistant session after detecting the wake word. For example, the first stage speech processor 124 may initiate the voice assistant session by providing the configuration data 132 to the audio preprocessor 118 and causing the audio data 150 to be provided to the second stage speech processor 154. In some implementations, the first stage speech processor 124 may cause the second stage speech processor 154 to be activated, such as described with reference to FIG. 14.

The method 1600 also includes, at block 1616, providing the speech of the first person to one or more voice assistant applications. For example, the audio data 150 of FIG. 1 is provided to the voice assistant application(s) 156. In this example, the audio data 150 includes portions of the audio data 116 that correspond to speech of the person 180A who spoke the wake word to initiate the voice assistant session.

The method 1600 also includes, at block 1618, disabling the speaker-specific speech input filter based on a determination that a voice assistant session associated with the first person has ended. For example, one or more components of the audio analyzer 140, such as the audio preprocessor 118, the first stage speech processor 124, or the second stage speech processor 154, may determine when a termination condition associated with the voice assistant session is satisfied. The termination condition may be satisfied based on an elapsed time associated with the voice assistant session, an elapsed time since speech was provided via the audio data 150, a termination instruction in the audio data 150, etc.

One benefit of selectively enabling speaker-specific filtering of audio data is that such filtering can improve accuracy of speech recognition by a voice assistant application. Another benefit of selectively enabling speaker-specific filtering of audio data is that such filtering can limit the ability of other persons to interrupt a voice assistant session.

The method 1600 of FIG. 16 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1600 of FIG. 16 may be performed by a processor that executes instructions, such as described with reference to FIG. 18.

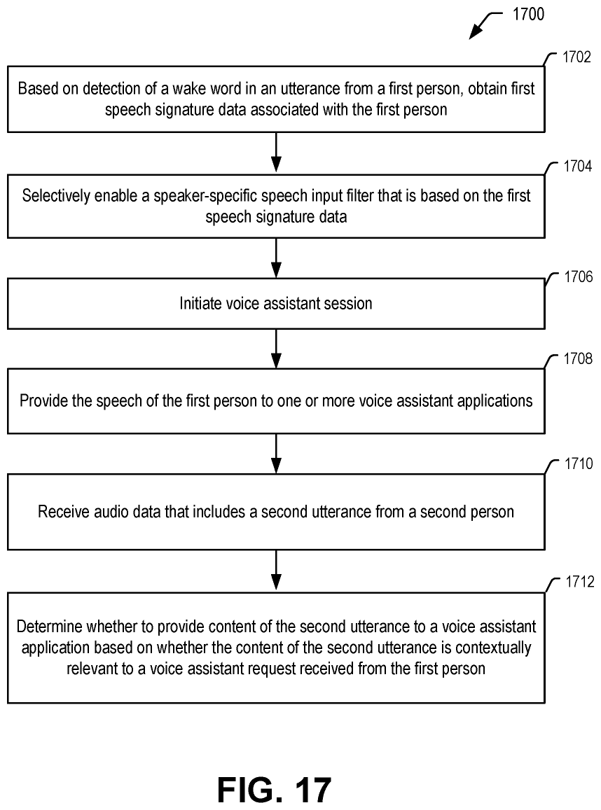

Referring to FIG. 17, a particular implementation of a method 1700 of selectively filtering audio data for speech processing is shown. In a particular aspect, one or more operations of the method 1700 are performed by at least one of the audio analyzer 140, the processor 190, the device 102, the system 100 of FIG. 1, or a combination thereof.

The method 1700 includes, at block 1702, based on detection of a wake word in an utterance from a first person, obtaining first speech signature data associated with the first person. For example, the audio preprocessor 118 may obtain the configuration data 132 of FIG. 1 based on the wake word detector 126 detecting the wake word 110 in the utterance 108A from the person 180A. In this example, the configuration data 132 includes at least speech signature data 134A associated with the person 180A.

The method 1700 includes, at block 1704, selectively enabling a speaker-specific speech input filter that is based on the first speech signature data. For example, the configuration data 132 of FIG. 1 enables the speech input filter 120 of the audio preprocessor 118 to operate in a speaker-specific mode.

The method 1700 also includes, at block 1706, initiating a voice assistant session based on detecting the wake word. For example, the first stage speech processor 124 may initiate the voice assistant session by providing the configuration data 132 to the audio preprocessor 118 and causing the audio data 150 to be provided to the second stage speech processor 154. In some implementations, the first stage speech processor 124 may cause the second stage speech processor 154 to be activated, as described with reference to FIG. 14.

The method 1700 also includes, at block 1708, providing the speech of the first person to one or more voice assistant applications. For example, the enhanced speech of the first person 508 of FIG. 5 is provided to the voice assistant application(s) 156. In this example, the enhanced speech of the first person 508 includes portions of the audio data 116 that correspond to speech of the person who spoke the wake word to initiate the voice assistant session.

The method 1700 also includes, at block 1710, receiving audio data that includes a second utterance from a second person. For example, in FIG. 5, the audio data 116 includes multi-person speech 302, which may include speech of the person who spoke the wake word to initiate the voice assistant session as well as speech from one or more other persons.

The method 1700 also includes, at block 1712, determining whether to provide content of the second utterance to a voice assistant application based on whether the content of the second utterance is contextually relevant to a voice assistant request received from the first person. For example, in FIG. 5, the latent-space representation 312 associated with the second utterance is processed via the second processing path to generate the enhanced speech of the second person(s) 516. In this example, the enhanced speech of the second person(s) 516 is provided to the NLP engine 520 along with context data 522 associated with the voice assistant session. The NLP engine 520 determines whether the enhanced speech of the second person(s) 516 is relevant to the voice assistant session, and if appropriate, provides the relevant speech of the second person(s) 524 to the voice assistant application(s) 156.

The method 1700 of FIG. 17 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 1700 of FIG. 17 may be performed by a processor that executes instructions, such as described with reference to FIG. 18.

Referring to FIG. 18, a block diagram of a particular illustrative implementation of a device is depicted and generally designated 1800. In various implementations, the device 1800 may have more or fewer components than illustrated in FIG. 18. In an illustrative implementation, the device 1800 may correspond to the device 102. In an illustrative implementation, the device 1800 may perform one or more operations described with reference to FIGS. 1-17.

In a particular implementation, the device 1800 includes a processor 1806 (e.g., a central processing unit (CPU)). The device 1800 may include one or more additional processors 1810 (e.g., one or more DSPs). In a particular aspect, the processor(s) 190 of FIG. 1 corresponds to the processor 1806, the processors 1810, or a combination thereof. The processor(s) 1810 may include a speech and music coder-decoder (CODEC) 1808 that includes a voice coder (“vocoder”) encoder 1836 and a vocoder decoder 1838. In the example illustrated in FIG. 18, the processor(s) 1810 also include the audio preprocessor 118, the first stage speech processor 124, and optionally, the second stage speech processor 154.

The device 1800 may include a memory 142 and a CODEC 1834. In particular implementations, the CODEC 604 of FIGS. 6 and 7 corresponds to the CODEC 1834 of FIG. 18. The memory 142 may include instructions 1856 that are executable by the one or more additional processors 1810 (or the processor 1806) to implement the functionality described with reference to the audio preprocessor 118, the first stage speech processor 124, the second stage speech processor 154, or a combination thereof. In the example illustrated in FIG. 18, the memory 142 also includes the enrollment data 136.

The device 1800 may include a display 1828 coupled to a display controller 1826. The audio transducer(s) 162, the microphone(s) 104, or both, may be coupled to the CODEC 1834. The CODEC 1834 may include a digital-to-analog converter (DAC) 1802, an analog-to-digital converter (ADC) 1804, or both. In a particular implementation, the CODEC 1834 may receive analog signals from the microphone(s) 104, convert the analog signals to digital signals (e.g. the audio data 116 of FIG. 1) using the analog-to-digital converter 1804, and provide the digital signals to the speech and music codec 1808. The speech and music codec 1808 may process the digital signals, and the digital signals may further be processed by the audio preprocessor 118, the first stage speech processor 124, the second stage speech processor 154, or a combination thereof. In a particular implementation, the speech and music codec 1808 may provide digital signals to the CODEC 1834. The CODEC 1834 may convert the digital signals to analog signals using the digital-to-analog converter 1802 and may provide the analog signals to the audio transducer(s) 162.

In a particular implementation, the device 1800 may be included in a system-in-package or system-on-chip device 1822. In a particular implementation, the memory 142, the processor 1806, the processors 1810, the display controller 1826, the CODEC 1834, and a modem 1854 are included in the system-in-package or system-on-chip device 1822. In a particular implementation, an input device 1830 and a power supply 1844 are coupled to the system-in-package or the system-on-chip device 1822. Moreover, in a particular implementation, as illustrated in FIG. 18, the display 1828, the input device 1830, the audio transducer(s) 162, the microphone(s) 104, an antenna 1852, and the power supply 1844 are external to the system-in-package or the system-on-chip device 1822. In a particular implementation, each of the display 1828, the input device 1830, the audio transducer(s) 162, the microphone(s) 104, the antenna 1852, and the power supply 1844 may be coupled to a component of the system-in-package or the system-on-chip device 1822, such as an interface or a controller.

In some implementations, the device 1800 include the modem 1854 coupled, via a transceiver 1850, to the antenna 1852. In some such implementations, the modem 1854 may be configured to send data associated with the utterance from the first person (e.g., at least a portion of the audio data 116 of FIG. 1) to a remote voice assistant server 1840. In such implementations, the voice assistant application(s) 156 execute at the voice assistant server 1840. In such implementations, the second stage speech processor 154 can be omitted from the device 1800; however, speaker-specific speech input filtering can be performed at the device 1800 based on wake word detection at the device 1800.

The device 1800 may include a smart speaker, a speaker bar, a mobile communication device, a smart phone, a cellular phone, a laptop computer, a computer, a tablet, a personal digital assistant, a display device, a television, a gaming console, a music player, a radio, a digital video player, a digital video disc (DVD) player, a tuner, a camera, a navigation device, a vehicle, a headset, an augmented reality headset, a mixed reality headset, a virtual reality headset, an aerial vehicle, a home automation system, a voice-activated device, a wireless speaker and voice activated device, a portable electronic device, a car, a computing device, a communication device, an internet-of-things (IoT) device, a virtual reality (VR) device, a base station, a mobile device, or any combination thereof.

In conjunction with the described implementations, an apparatus includes means for obtaining, based on detection of a wake word in an utterance from a first person, first speech signature data associated with the first person. For example, the means for obtaining the first speech signature data can correspond to the device 102, the processor(s) 190, the audio analyzer 140, the audio preprocessor 118, the speech input filter(s) 120, the first stage speech processor 124, the speaker detector 128, the integrated circuit 802, the processor 1806, the processor(s) 1810, one or more other circuits or components configured to obtain the speech signature data, or any combination thereof.

The apparatus also includes means for selectively enabling a speaker-specific speech input filter that is based on the first speech signature data. For example, the means for selectively enabling the speaker-specific speech input filter can correspond to the device 102, the processor(s) 190, the audio analyzer 140, the audio preprocessor 118, the speech input filter(s) 120, the first stage speech processor 124, the speaker detector 128, the integrated circuit 802, the processor 1806, the processor(s) 1810, one or more other circuits or components configured to selectively enable a speaker-specific speech input filter, or any combination thereof.

In some implementations, a non-transitory computer-readable medium (e.g., a computer-readable storage device, such as the memory 142) includes instructions (e.g., the instructions 1856) that, when executed by one or more processors (e.g., the one or more processors 190, the one or more processors 1810, or the processor 1806), cause the one or more processors to, based on detection of a wake word in an utterance from a first person, obtain first speech signature data associated with the first person, and selectively enable a speaker-specific speech input filter that is based on the first speech signature data.

Particular aspects of the disclosure are described below in sets of interrelated

### EXAMPLES

According to Example 1, a device includes one or more processors configured to: based on detection of a wake word in an utterance from a first person, obtain first speech signature data associated with the first person; and selectively enable a speaker-specific speech input filter that is based on the first speech signature data.

Example 2 includes the device of Example 1, wherein the one or more processors are further configured to process audio data including speech from multiple persons to detect the wake word.

Example 3 includes the device of Example 1 or Example 2, wherein obtaining the first speech signature data includes selecting the first speech signature data from a set of speech signature data associated with a plurality of persons based on comparison of features of the utterance to enrollment data.

Example 4 includes the device of any of Examples 1 to 3, wherein the speaker-specific speech input filter is configured to separate speech of the first person from speech of one or more other persons and to provide the speech of the first person to one or more voice assistant applications.

Example 5 includes the device of any of Examples 1 to 4, wherein the speaker-specific speech input filter is configured to remove or attenuate, from audio data, sounds that are not associated with speech from the first person.

Example 6 includes the device of any of Examples 1 to 5, wherein the speaker-specific speech input filter is configured to compare input audio data to the first speech signature data to generate output audio data that de-emphasizes portions of the input audio data that do not correspond to speech from the first person.

Example 7 includes the device of any of Examples 1 to 6, wherein the one or more processors are further configured to, based on detection of the wake word: obtain, based on configuration data, second speech signature data associated with at least one second person; and configure the speaker-specific speech input filter based on the first speech signature data and the second speech signature data.

Example 8 includes the device of any of Examples 1 to 6, wherein the one or more processors are further configured to, after enabling the speaker-specific speech input filter based on the first speech signature data: receive audio data that includes a second utterance from a second person; and determine whether to provide content of the second utterance to a voice assistant application based on whether the content of the second utterance is contextually relevant to a voice assistant request received from the first person.

Example 9 includes the device of any of Examples 1 to 8, wherein the one or more processors are further configured to: when the speaker-specific speech input filter is enabled, provide first audio data to a first speech enhancement model based on the first speech signature data; and when the speaker-specific speech input filter is not enabled, provide second audio data to a second speech enhancement model based on second speech signature data.

Example 10 includes the device of Example 9, wherein the second speech signature data represents speech of multiple persons.

Example 11 includes the device of any of Examples 1 to 10, wherein the one or more processors are further configured to, after enabling the speaker-specific speech input filter, disable the speaker-specific speech input filter based on a determination that a voice assistant session associated with the first person has ended.

Example 12 includes the device of Example 11, wherein the one or more processors are further configured to, during the voice assistant session: receive first audio data representing multi-person speech; generate, based on the speaker-specific speech input filter, second audio data representing single-person speech; and provide the second audio data to a voice assistant application.

Example 13 includes the device of any of Examples 1 to 12, wherein the first speech signature data corresponds to a first speaker embedding, and wherein the one or more processors are configured to enable the speaker-specific speech input filter by providing the first speaker embedding as an input to a speech enhancement model.

Example 14 includes the device of any of Examples 1 to 13, wherein the one or more processors are integrated into a vehicle.

Example 15 includes the device of any of Examples 1 to 13,wherein the one or more processors are integrated into at least one of a smart speaker, a speaker bar, a smart phone, a cellular phone, a laptop computer, a computer, a tablet, a personal digital assistant, a display device, a television, a gaming console, a music player, a radio, a digital video player, a tuner, a camera, a navigation device, a headset, an augmented reality headset, a mixed reality headset, a virtual reality headset, a home automation system, a voice-activated device, a wireless speaker and voice activated device, a portable electronic device, a communication device, an internet-of-things (IoT) device, an extended reality (XR) device, a base station, or a mobile device.

Example 16 includes the device of any of Examples 1 to 15, further including a microphone configured to capture sound including the utterance from the first person.

Example 17 includes the device of any of Examples 1 to 16, further including a modem configured to send data associated with the utterance from the first person to a remote voice assistant server.

Example 18 includes the device of any of Examples 1 to 17, further including an audio transducer configured to output sound corresponding to a voice assistant response to the first person.

According to Example 19, a method includes: based on detection of a wake word in an utterance from a first person, obtaining first speech signature data associated with the first person; and selectively enabling a speaker-specific speech input filter that is based on the first speech signature data.

Example 20 includes the method of Example 19, further including processing audio data including speech from multiple persons to detect the wake word.

Example 21 includes the method of Example 19 or Example 20, wherein obtaining the first speech signature data includes selecting the first speech signature data from a set of speech signature data associated with a plurality of persons based on comparison of features of the utterance to enrollment data.

Example 22 includes the method of any of Examples 19 to 21, further including: separating, by the speaker-specific speech input filter, speech of the first person from speech of one or more other persons; and providing the speech of the first person to one or more voice assistant applications.

Example 23 includes the method of any of Examples 19 to 22, further including removing or attenuating, by the speaker-specific speech input filter, sounds from audio data that are not associated with speech from the first person.

Example 24 includes the method of any of Examples 19 to 23, further including comparing, by the speaker-specific speech input filter, input audio data to the first speech signature data to generate output audio data that de-emphasizes portions of the input audio data that do not correspond to speech from the first person.

Example 25 includes the method of any of Examples 19 to 24, further including, based on detection of the wake word: obtaining, based on configuration data, second speech signature data associated with at least one second person; and configuring the speaker-specific speech input filter based on the first speech signature data and the second speech signature data.

Example 26 includes the method of any of Examples 19 to 24, further including, after enabling the speaker-specific speech input filter based on the first speech signature data: receiving audio data that includes a second utterance from a second person; and determining whether to provide content of the second utterance to a voice assistant application based on whether the content of the second utterance is contextually relevant to a voice assistant request received from the first person.

Example 27 includes the method of any of Examples 19 to 26, further including: when the speaker-specific speech input filter is enabled, providing first audio data to a first speech enhancement model based on the first speech signature data; and when the speaker-specific speech input filter is not enabled, providing second audio data to a second speech enhancement model based on second speech signature data.

Example 28 includes the method of Example 27, wherein the second speech signature data represents speech of multiple persons.

Example 29 includes the method of any of Examples 19 to 28, further including, after enabling the speaker-specific speech input filter, disabling the speaker-specific speech input filter based on a determination that a voice assistant session associated with the first person has ended.

Example 30 includes the method of Example 29, further including, during the voice assistant session: receiving first audio data representing multi-person speech; generating, based on the speaker-specific speech input filter, second audio data representing single-person speech; and providing the second audio data to a voice assistant application.

Example 31 includes the method of any of Examples 19 to 30, wherein the first speech signature data corresponds to a first speaker embedding, and wherein enabling the speaker-specific speech input filter includes providing the first speaker embedding as an input to a speech enhancement model.

According to Example 32, a non-transient computer-readable medium stores instructions that are executable by one or more processors to cause the one or more processors to: based on detection of a wake word in an utterance from a first person, obtain first speech signature data associated with the first person; and selectively enable a speaker-specific speech input filter that is based on the first speech signature data.

Example 33 includes the non-transient computer-readable medium of Example 32, wherein the instructions are further executable to cause the one or more processors to process audio data including speech from multiple persons to detect the wake word.

Example 34 includes the non-transient computer-readable medium of Example 32 or Example 33, wherein obtaining the first speech signature data includes selecting the first speech signature data from a set of speech signature data associated with a plurality of persons based on comparison of features of the utterance to enrollment data.

Example 35 includes the non-transient computer-readable medium of any of Examples 32 to 34, wherein the speaker-specific speech input filter is configured to separate speech of the first person from speech of one or more other persons and to provide the speech of the first person to one or more voice assistant applications.

Example 36 includes the non-transient computer-readable medium of any of Examples 32 to 35, wherein the speaker-specific speech input filter is configured to remove or attenuate, from audio data, sounds that are not associated with speech from the first person.

Example 37 includes the non-transient computer-readable medium of any of Examples 32 to 36, wherein the speaker-specific speech input filter is configured to compare input audio data to the first speech signature data to generate output audio data that de-emphasizes portions of the input audio data that do not correspond to speech from the first person.

Example 38 includes the non-transient computer-readable medium of any of Examples 32 to 37, wherein the instructions are further executable to cause the one or more processors to, based on detection of the wake word: obtain, based on configuration data, second speech signature data associated with at least one second person; and configure the speaker-specific speech input filter based on the first speech signature data and the second speech signature data.

Example 39 includes the non-transient computer-readable medium of any of Examples 32 to 37, wherein the instructions are further executable to cause the one or more processors to, after enabling the speaker-specific speech input filter based on the first speech signature data: receive audio data that includes a second utterance from a second person; and determine whether to provide content of the second utterance to a voice assistant application based on whether the content of the second utterance is contextually relevant to a voice assistant request received from the first person.

Example 40 includes the non-transient computer-readable medium of any of Examples 32 to 39, wherein the instructions are further executable to cause the one or more processors to: when the speaker-specific speech input filter is enabled, provide first audio data to a first speech enhancement model based on the first speech signature data; and when the speaker-specific speech input filter is not enabled, provide second audio data to a second speech enhancement model based on second speech signature data.

Example 41 includes the non-transient computer-readable medium of Example 40, wherein the second speech signature data represents speech of multiple persons.

Example 42 includes the non-transient computer-readable medium of any of Examples 32 to 41, wherein the instructions are further executable to cause the one or more processors to, after enabling the speaker-specific speech input filter, disable the speaker-specific speech input filter based on a determination that a voice assistant session associated with the first person has ended.

Example 43 includes the non-transient computer-readable medium of Example 42, wherein the instructions are further executable to cause the one or more processors to, during the voice assistant session: receive first audio data representing multi-person speech; generate, based on the speaker-specific speech input filter, second audio data representing single-person speech; and provide the second audio data to a voice assistant application.

Example 44 includes the non-transient computer-readable medium of any of Examples 32 to 43, wherein the first speech signature data corresponds to a first speaker embedding, and wherein the instructions are further executable to cause the one or more processors to enable the speaker-specific speech input filter by providing the first speaker embedding as an input to a speech enhancement model.

According to Example 45, an apparatus includes: means for obtaining, based on detection of a wake word in an utterance from a first person, first speech signature data associated with the first person; and means for selectively enabling a speaker-specific speech input filter that is based on the first speech signature data.

Example 46 includes the apparatus of Example 45, further including means for processing audio data including speech from multiple persons to detect the wake word.

Example 47 includes the apparatus of Example 45 or Example 46, wherein the means for obtaining the first speech signature data includes means for selecting the first speech signature data from a set of speech signature data associated with a plurality of persons based on comparison of features of the utterance to enrollment data.

Example 48 includes the apparatus of any of Examples 45 to 47, wherein the speaker-specific speech input filter includes: means for separating speech of the first person from speech of one or more other persons; and means for providing the speech of the first person to one or more voice assistant applications.

Example 49 includes the apparatus of any of Examples 45 to 48, wherein the speaker-specific speech input filter includes means for removing or attenuating sounds from audio data that are not associated with speech from the first person.

Example 50 includes the apparatus of any of Examples 45 to 49, wherein the speaker-specific speech input filter includes means for comparing input audio data to the first speech signature data to generate output audio data that de-emphasizes portions of the input audio data that do not correspond to speech from the first person.

Example 51 includes the apparatus of any of Examples 45 to 50, further including: means for obtaining, based on configuration data, second speech signature data associated with at least one second person; and means for configuring the speaker-specific speech input filter based on the first speech signature data and the second speech signature data.

Example 52 includes the apparatus of any of Examples 45 to 50, further including: means for receiving audio data that includes a second utterance from a second person while the speaker-specific speech input filter is enabled based on the first speech signature data; and means for determining whether to provide content of the second utterance to a voice assistant application based on whether the content of the second utterance is contextually relevant to a voice assistant request received from the first person.

Example 53 includes the apparatus of any of Examples 45 to 52, further including: means for providing first audio data to a first speech enhancement model based on the first speech signature data when the speaker-specific speech input filter is enabled; and means for providing second audio data to a second speech enhancement model based on second speech signature data when the speaker-specific speech input filter is not enabled.

Example 54 includes the apparatus of Example 53, wherein the second speech signature data represents speech of multiple persons.

Example 55 includes the apparatus of any of Examples 45 to 54, further including means for disabling the speaker-specific speech input filter based on a determination that a voice assistant session associated with the first person has ended.

Example 56 includes the apparatus of Example 55, further including: means for receiving first audio data representing multi-person speech during the voice assistant session; means for generating, based on the speaker-specific speech input filter, second audio data representing single-person speech; and means for providing the second audio data to a voice assistant application.

Example 57 includes the apparatus of any of Examples 45 to 56, wherein the first speech signature data corresponds to a first speaker embedding, and wherein the means for selectively enabling the speaker-specific speech input filter includes means for providing the first speaker embedding as an input to a speech enhancement model.

Example 58 includes the apparatus of any of Examples 45 to 57, wherein the means for obtaining the first speech signature data associated with the first person and the means for selectively enabling the speaker-specific speech input filter are integrated into a vehicle.

Example 59 includes the apparatus of any of Examples 45 to 57, wherein the means for obtaining the first speech signature data associated with the first person and the means for selectively enabling the speaker-specific speech input filter are integrated into at least one of a smart speaker, a speaker bar, a smart phone, a cellular phone, a laptop computer, a computer, a tablet, a personal digital assistant, a display device, a television, a gaming console, a music player, a radio, a digital video player, a tuner, a camera, a navigation device, a headset, an augmented reality headset, a mixed reality headset, a virtual reality headset, a home automation system, a voice-activated device, a wireless speaker and voice activated device, a portable electronic device, a communication device, an internet-of-things (IoT) device, an extended reality (XR) device, a base station, or a mobile device.

Example 60 includes the apparatus of any of Examples 45 to 59, further including means for capturing sound including the utterance from the first person.

Example 61 includes the apparatus of any of Examples 45 to 60, further including means for sending data associated with the utterance from the first person to a remote voice assistant server.

Example 62 includes the apparatus of any of Examples 45 to 61, further including means for outputting sound corresponding to a voice assistant response to the first person.

Those of skill would further appreciate that the various illustrative logical blocks, configurations, modules, circuits, and algorithm steps described in connection with the implementations disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
one or more processors configured to:
based on detection of a wake word in an utterance from a first person, obtain first speech signature data associated with the first person; and
selectively enable a speaker-specific speech input filter that is based on the first speech signature data.

2. The device of claim 1, wherein the one or more processors are further configured to process audio data including speech from multiple persons to detect the wake word.

3. The device of claim 1, wherein obtaining the first speech signature data comprises selecting the first speech signature data from a set of speech signature data associated with a plurality of persons based on comparison of features of the utterance to enrollment data.

4. The device of claim 1, wherein the speaker-specific speech input filter is configured to separate speech of the first person from speech of one or more other persons and to provide the speech of the first person to one or more voice assistant applications.

5. The device of claim 1, wherein the speaker-specific speech input filter is configured to remove or attenuate, from audio data, sounds that are not associated with speech from the first person.

6. The device of claim 1, wherein the speaker-specific speech input filter is configured to compare input audio data to the first speech signature data to generate output audio data that de-emphasizes portions of the input audio data that do not correspond to speech from the first person.

7. The device of claim 1, wherein the one or more processors are further configured to, based on detection of the wake word:
obtain, based on configuration data, second speech signature data associated with at least one second person; and
configure the speaker-specific speech input filter based on the first speech signature data and the second speech signature data.

8. The device of claim 1, wherein the one or more processors are further configured to, after enabling the speaker-specific speech input filter based on the first speech signature data:
receive audio data that includes a second utterance from a second person; and
determine whether to provide content of the second utterance to a voice assistant application based on whether the content of the second utterance is contextually relevant to a voice assistant request received from the first person.

9. The device of claim 1, wherein the one or more processors are further configured to:
when the speaker-specific speech input filter is enabled, provide first audio data to a first speech enhancement model based on the first speech signature data; and
when the speaker-specific speech input filter is not enabled, provide second audio data to a second speech enhancement model based on second speech signature data.

10. The device of claim 9, wherein the second speech signature data represents speech of multiple persons.

11. The device of claim 1, wherein the one or more processors are further configured to, after enabling the speaker-specific speech input filter, disable the speaker-specific speech input filter based on a determination that a voice assistant session associated with the first person has ended.

12. The device of claim 11, wherein the one or more processors are further configured to, during the voice assistant session:
receive first audio data representing multi-person speech;
generate, based on the speaker-specific speech input filter, second audio data representing single-person speech; and
provide the second audio data to a voice assistant application.

13. The device of claim 1, wherein the first speech signature data corresponds to a first speaker embedding, and wherein the one or more processors are configured to enable the speaker-specific speech input filter by providing the first speaker embedding as an input to a speech enhancement model.

14. The device of claim 1, wherein the one or more processors are integrated into a vehicle.

15. The device of claim 1, wherein the one or more processors are integrated into at least one of a smart speaker, a speaker bar, a smart phone, a cellular phone, a laptop computer, a computer, a tablet, a personal digital assistant, a display device, a television, a gaming console, a music player, a radio, a digital video player, a tuner, a camera, a navigation device, a headset, an augmented reality headset, a mixed reality headset, a virtual reality headset, a home automation system, a voice-activated device, a wireless speaker and voice activated device, a portable electronic device, a communication device, an internet-of-things (IoT) device, an extended reality (XR) device, a base station, or a mobile device.

16. The device of claim 1, further comprising a microphone configured to capture sound including the utterance from the first person.

17. The device of claim 1, further comprising a modem configured to send data associated with the utterance from the first person to a remote voice assistant server.

18. The device of claim 1, further comprising one or more audio transducers configured to output sound corresponding to a voice assistant response to the first person.

19. A method comprising:
based on detection of a wake word in an utterance from a first person, obtaining first speech signature data associated with the first person; and
selectively enabling a speaker-specific speech input filter that is based on the first speech signature data.

20. The method of claim 19, wherein obtaining the first speech signature data comprises selecting the first speech signature data from a set of speech signature data associated with a plurality of persons based on comparison of features of the utterance to enrollment data.

21. The method of claim 19, further comprising:
separating, by the speaker-specific speech input filter, speech of the first person from speech of one or more other persons; and
providing the speech of the first person to one or more voice assistant applications.

22. The method of claim 19, further comprising removing or attenuating, by the speaker-specific speech input filter, sounds from audio data that are not associated with speech from the first person.

23. The method of claim 19, further comprising comparing, by the speaker-specific speech input filter, input audio data to the first speech signature data to generate output audio data that de-emphasizes portions of the input audio data that do not correspond to speech from the first person.

24. The method of claim 19, further comprising, after enabling the speaker-specific speech input filter based on the first speech signature data:
receiving audio data that includes a second utterance from a second person; and
determining whether to provide content of the second utterance to a voice assistant application based on whether the content of the second utterance is contextually relevant to a voice assistant request received from the first person.

25. The method of claim 19, further comprising:
when the speaker-specific speech input filter is enabled, providing first audio data to a first speech enhancement model based on the first speech signature data; and
when the speaker-specific speech input filter is not enabled, providing second audio data to a second speech enhancement model based on second speech signature data.

26. The method of claim 19, wherein the first speech signature data corresponds to a first speaker embedding, and wherein enabling the speaker-specific speech input filter comprises providing the first speaker embedding as an input to a speech enhancement model.

27. A non-transient computer-readable medium storing instructions that are executable by one or more processors to cause the one or more processors to:
based on detection of a wake word in an utterance from a first person, obtain first speech signature data associated with the first person; and
selectively enable a speaker-specific speech input filter that is based on the first speech signature data.

28. An apparatus comprising:
means for obtaining, based on detection of a wake word in an utterance from a first person, first speech signature data associated with the first person; and
means for selectively enabling a speaker-specific speech input filter that is based on the first speech signature data.
